(19) United States
(12) Patent Application Publication
(10) Pub. No.: US 2023/0305161 A1
(43) Pub. Date: Sep. 28, 2023

(54) REAL-TIME MONITORING DC OFFSET OF ADC DATA OF LIDAR SYSTEM

(71) Applicant: Innovusion, Inc., Sunnyvale, CA (US)

(72) Inventors: Xiandong Leng, San Jose, CA (US); Junwei Bao, Los Altos, CA (US)

(73) Assignee: Innovusion, Inc., Sunnyvale, CA (US)

(21) Appl. No.: 18/126,240

(22) Filed: Mar. 24, 2023

Related U.S. Application Data
(60) Provisional application No. 63/324,010, filed on Mar. 25, 2022.

(51) Int. Cl. G06T 7/11; G01S 17/894; G01S 17/931

(52) U.S. Cl. CPC G01S 17/931; G01S 17/894; G06T 7/11; G06T 2207/10028

(57) ABSTRACT

A Light Detection and Ranging (LiDAR) system is disclosed. The LiDAR system comprises a light source configured to provide transmission light signals in a plurality of firing cycles. The LiDAR system comprises a detector configured to detect return signals formed based on the transmission light signals. The LiDAR system comprises an analog-to-digital converter (ADC) configured to obtain ADC data representing the detected return signals. The LiDAR system further comprises one or more processors and memory device, and processor-executable instructions stored in the memory device. The processor-executable instructions can cause the one or more processors to perform: determining a multiple-point time window using the ADC data; based on the multiple-point time window, determining an offset of the ADC data; at least partially correcting the ADC data based on the offset; and providing the corrected ADC data for constructing a point cloud representing an external environment of the LiDAR system.

### CROSS-REFERENCE TO RELATED APPLICATIONS

This application claims priority to U.S. Provisional Pat. Application Serial No. 63/324,010, filed Mar. 25, 2022, entitled “REAL-TIME MONITORING DC OFFSET OF ADC DATA OF LIDAR SYSTEM,” the content of which is hereby incorporated by reference in its entirety for all purposes.

### FIELD OF THE TECHNOLOGY

This disclosure relates generally to light detection and processing and, more particularly, to real-time monitoring of DC offsets of analog-to-digital (ADC) data of a LiDAR system.

### BACKGROUND

Light detection and ranging (LiDAR) systems use light pulses to create an image or point cloud of the external environment. A LiDAR system may be a scanning or non-scanning system. Some typical scanning LiDAR systems include a light source, a light transmitter, a light steering system, and a light detector. The light source generates a light beam that is directed by the light steering system in particular directions when being transmitted from the LiDAR system. When a transmitted light beam is scattered or reflected by an object, a portion of the scattered or reflected light returns to the LiDAR system to form a return light pulse. The light detector detects the return light pulse. Using the difference between the time that the return light pulse is detected and the time that a corresponding light pulse in the light beam is transmitted, the LiDAR system can determine the distance to the object based on the speed of light. This technique of determining the distance is referred to as the time-of-flight (ToF) technique. The light steering system can direct light beams along different paths to allow the LiDAR system to scan the surrounding environment and produce images or point clouds. A typical non-scanning LiDAR system illuminate an entire field-of-view (FOV) rather than scanning through the FOV. An example of the non-scanning LiDAR system is a flash LiDAR, which can also use the ToF technique to measure the distance to an object. LiDAR systems can also use techniques other than time-of-flight and scanning to measure the surrounding environment.

### SUMMARY

An analog to digital converter (ADC) is a device of a LiDAR system to acquire and digitize time of flight (ToF) signals. A feature of the ADC signals is that the entire signal line may have a direct-current (DC) offset. The DC offset can introduce errors of the ADC signals. Because the ADC signals represent the signal intensities of the light pulses received by the LiDAR system, erroneous ADC signals may impact the downstream processing and in turn the accuracy and quality of the point cloud data. Therefore, correcting the DC offset from the ADC signals may be needed for the ADC data to be used to construct the LiDAR point cloud.

Embodiments of the present disclosure provides a method to monitor the real-time DC offset of each firing cycle, so that the ADC data of each firing cycle can be corrected using the corresponding DC offset. To monitor the DC offset of each firing cycle, a multiple-point time window (e.g., a 16-point time window) is selected in the vicinity of the laser triggering point of a current firing cycle. The DC offset is calculated based on the multiple-point time window, and the ADC data of the current firing cycle can then be corrected with this DC offset. The advantage of the disclosed method is that the ADC signals of all firing cycles can be shifted to the base of about zero or be minimized, thereby improving the accuracy of the ADC data and in turn the accuracy of the point cloud data.

In one embodiment, a light detection and ranging (LiDAR) system is provided. The LiDAR system includes a light source, a detector, an analog-to-digital converter (ADC), one or more processors and memory device and processor-executable instructions stored in the memory device. The light source is configured to provide transmission light signals in a plurality of firing cycles. The detector is configured to detect return signals formed based on the transmission light signals. The ADC is configured to obtain ADC data representing the detected return signals. The processor-executable instructions stored in the memory device, when executed by the one or more processors, can cause the one or more processors to perform the following operations. The operations comprise, for at least one firing cycle of the plurality of firing cycles, determining a multiple-point time window using the ADC data; based on the multiple-point time window, determining an offset of the ADC data; at least partially correcting the ADC data based on the offset; and providing the corrected ADC data for constructing a point cloud representing an external environment of the LiDAR system.

In one embodiment, a method for real-time offset monitoring for light detection and ranging (LiDAR) is provided. The method comprises providing, by a light source, transmission light signals in a plurality of firing cycles. The method further comprises detecting, by a detector, return signals formed based on the transmission light signals. The method further comprises obtaining, by an analog-to-digital converter (ADC), ADC data representing the detected return signals. The method further comprises executing, by one or more processors and memory device, processor-executable instructions to cause the one or more processors to perform the following operations. The operations comprise, for at least one firing cycle of the plurality of firing cycles, determining a multiple-point time window using the ADC data; based on the multiple-point time window, determining an offset of the ADC data; at least partially correcting the ADC data based on the offset; and providing the corrected ADC data for constructing a point cloud representing an external environment of the LiDAR system.

In one embodiment, a non-transitory computer readable medium is provided. The non-transitory computer readable medium stores processor-executable instructions for performing correction of analog-to-digital (ADC) data obtained based on transmission light signals associated with a plurality of firing cycles. The instructions, when executed by one or more processors of an electronic device, cause the electronic device to perform a method for real-time offset monitoring for light detection and ranging (LiDAR). The method comprises providing, by a light source, transmission light signals in a plurality of firing cycles. The method further comprises detecting, by a detector, return signals formed based on the transmission light signals. The method further comprises obtaining, by an analog-to-digital converter (ADC), ADC data representing the detected return signals. The method further comprises executing, by one or more processors and memory device, processor-executable instructions to cause the one or more processors to perform the following operations. The operations comprise, for at least one firing cycle of the plurality of firing cycles, determining a multiple-point time window using the ADC data; based on the multiple-point time window, determining an offset of the ADC data; at least partially correcting the ADC data based on the offset; and providing the corrected ADC data for constructing a point cloud representing an external environment of the LiDAR system.

In one embodiment, a vehicle is provided. The vehicle comprises a LiDAR system. The LiDAR system includes a light source, a detector, an analog-to-digital converter (ADC), one or more processors and memory device and processor-executable instructions stored in the memory device. The light source is configured to provide transmission light signals in a plurality of firing cycles. The detector is configured to detect return signals formed based on the transmission light signals. The ADC is configured to obtain ADC data representing the detected return signals. The processor-executable instructions stored in the memory device, when executed by the one or more processors, can cause the one or more processors to perform the following operations. The operations comprise, for at least one firing cycle of the plurality of firing cycles, determining a multiple-point time window using the ADC data; based on the multiple-point time window, determining an offset of the ADC data; at least partially correcting the ADC data based on the offset; and providing the corrected ADC data for constructing a point cloud representing an external environment of the LiDAR system.

### BRIEF DESCRIPTION OF THE DRAWINGS

The present application can be best understood by reference to the embodiments described below taken in conjunction with the accompanying drawing figures, in which like parts may be referred to by like numerals.

FIG. 1 illustrates one or more example LiDAR systems disposed or included in a motor vehicle.

FIG. 2 is a block diagram illustrating interactions between an example LiDAR system and multiple other systems including a vehicle perception and planning system.

FIG. 3 is a block diagram illustrating an example LiDAR system.

FIG. 4 is a block diagram illustrating an example fiber-based laser source.

FIGS. 5A-5C illustrate an example LiDAR system using pulse signals to measure distances to objects disposed in a field-of-view (FOV).

FIG. 6 is a block diagram illustrating an example apparatus used to implement systems, apparatus, and methods in various embodiments.

FIG. 7 is a block diagram illustrating an example LiDAR system having an optical receiver and light detector for detecting and processing return signals according to an embodiment.

FIG. 8 illustrates example ADC data and laser triggers in multiple continuous firing cycles.

FIGS. 9A-9D illustrate example ADC data with different selections of multiple-point time window positions.

FIG. 10 is a zoomed-in view illustrating an example 16-point window for calculating DC offset.

FIG. 11 illustrates exemplary offset corrected ADC data in multiple continuous firing cycles.

FIG. 12 is a flowchart illustrating using an exemplary method for real-time monitoring of DC offsets of analog-to-digital (ADC) data of a LiDAR system.

FIG. 13 is a flowchart illustrating using an exemplary method for real-time monitoring of a frame offset of analog-to-digital (ADC) data of a LiDAR system.

FIG. 14 is a flowchart illustrating using an exemplary method for real-time monitoring of a frame offset of analog-to-digital (ADC) data of a LiDAR system.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

A LiDAR system is a frequently-used component of a motor vehicle. An analog to digital converter (ADC) is a device of a LiDAR system to acquire and digitize time of flight (ToF) signals. The ToF signals represent return light formed by scattering and/or reflecting transmission light from one or more objects in a field-of-view (FOV). The ADC signals are processed by a set of algorithms to reconstruct the final 3-D point cloud images. A feature of the ADC signals is that the entire signal line may have an offset including a direct-current (DC) offset. A DC offset is a value caused by, for example, the fluctuation of the background noise of the ADC signals. The DC offset can introduce errors of the ADC signals. Because the ADC signals represent the signal intensities of the light pulses received by the LiDAR system, erroneous ADC signals may impact the downstream processing and in turn the accuracy and quality of the point cloud data. For example, distances and/or reflectivity measurements derived from the erroneous ADC signals may be inaccurate. The inaccuracy of the measurements may in turn impact the perception and planning system of a vehicle, which may result in reduced safety and reliability. Therefore, correcting the DC offset from the ADC signals may be needed for the ADC data to be used to construct the LiDAR point cloud. One way to mitigate the DC offset problem is to use a constant value regardless of the true DC offset of each firing cycle, and correct the ADC data with the constant value. However, DC offset can vary between firing cycles due to temperature, object features (e.g., the shape and distance of an object), and many other factors, which means using a constant value as DC offset may be improper or insufficient to correct the ADC data. A real-time DC offset of each firing cycle may thus be useful to correct the ADC data in real time. In the present disclosure, the ADC signals having an offset is also referred to as having an DC offset, even if the ADC signals may also have an AC component.

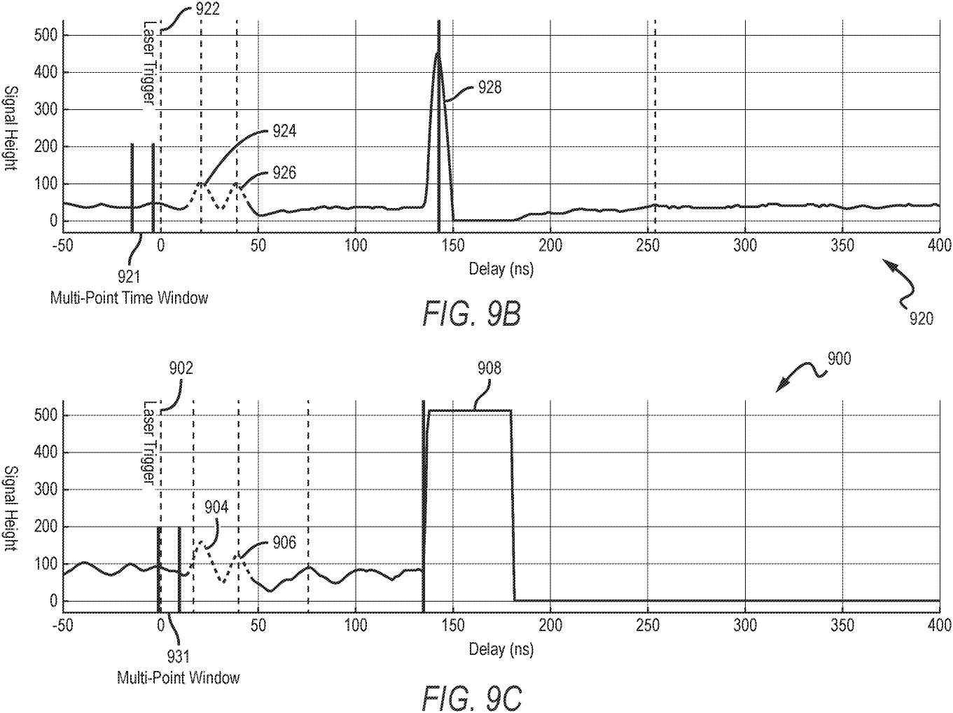

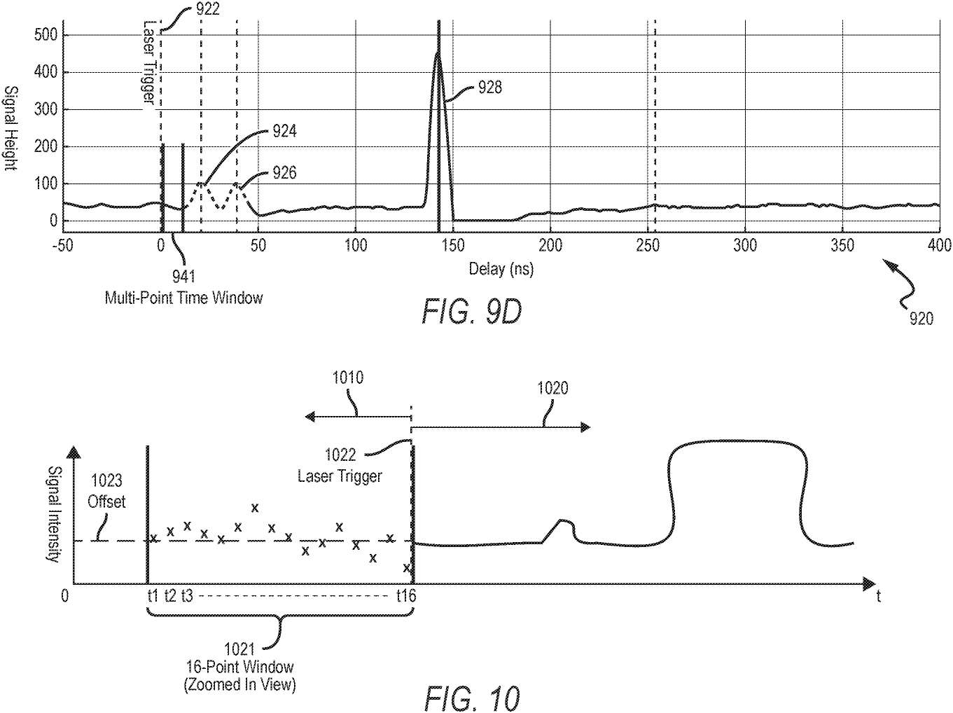

Embodiments of the present disclosure provides a method to monitor the real-time DC offset of each firing cycle, so that the ADC data of each firing cycle can be corrected using the corresponding DC offset. A firing cycle begins at a time position of laser triggering to provide a transmission light pulse and ends at the next time position of the laser triggering to provide the next transmission light pulse. In the below descriptions and illustrations, the laser triggering point is shown as the zero delay time (see e.g., FIGS. 9A and 9B). To monitor the DC offset of each firing cycle, a multiple-point time window (e.g., a 16-point time window) is selected in the vicinity of the laser triggering point of a current firing cycle. For example, the multiple-point time window may be selected at a time location in the previous firing cycle right before the laser triggering time position, where the ADC data likely represent mostly background noise but no signal pulses. The DC offset is calculated based on the multiple-point time window, and the ADC data of the current firing cycle can then be corrected with this DC offset. In the next firing cycle, a new multiple-point time window is selected and thus a new DC offset can be calculated. In this manner, the real-time DC offset can be obtained for each firing cycle for correcting the ADC data. The advantage of the disclosed method is that the ADC signals of all firing cycles can be shifted to the base of about zero or be minimized, thereby improving the accuracy of the ADC data and in turn the accuracy of the point cloud data.

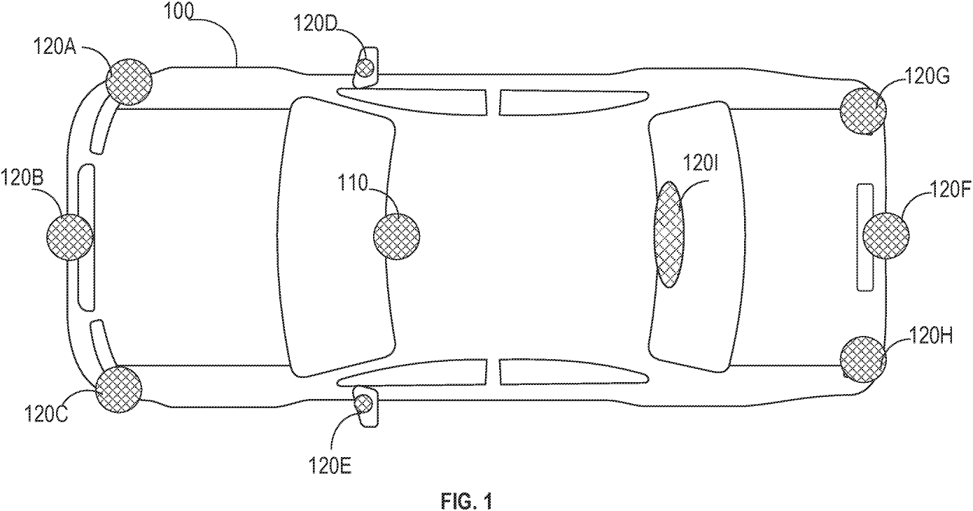

FIG. 1 illustrates one or more example LiDAR systems 110 disposed or included in a motor vehicle 100. Vehicle 100 can be a car, a sport utility vehicle (SUV), a truck, a train, a wagon, a bicycle, a motorcycle, a tricycle, a bus, a mobility scooter, a tram, a ship, a boat, an underwater vehicle, an airplane, a helicopter, a unmanned aviation vehicle (UAV), a spacecraft, etc. Motor vehicle 100 can be a vehicle having any automated level. For example, motor vehicle 100 can be a partially automated vehicle, a highly automated vehicle, a fully automated vehicle, or a driverless vehicle. A partially automated vehicle can perform some driving functions without a human driver’s intervention. For example, a partially automated vehicle can perform blind-spot monitoring, lane keeping and/or lane changing operations, automated emergency braking, smart cruising and/or traffic following, or the like. Certain operations of a partially automated vehicle may be limited to specific applications or driving scenarios (e.g., limited to only freeway driving). A highly automated vehicle can generally perform all operations of a partially automated vehicle but with less limitations. A highly automated vehicle can also detect its own limits in operating the vehicle and ask the driver to take over the control of the vehicle when necessary. A fully automated vehicle can perform all vehicle operations without a driver’s intervention but can also detect its own limits and ask the driver to take over when necessary. A driverless vehicle can operate on its own without any driver intervention.

In typical configurations, motor vehicle 100 comprises one or more LiDAR systems 110 and 120A-120I. Each of LiDAR systems 110 and 120A-120I can be a scanning-based LiDAR system and/or a non-scanning LiDAR system (e.g., a flash LiDAR). A scanning-based LiDAR system scans one or more light beams in one or more directions (e.g., horizontal and vertical directions) to detect objects in a field-of-view (FOV). A non-scanning based LiDAR system transmits laser light to illuminate an FOV without scanning. For example, a flash LiDAR is a type of non-scanning based LiDAR system. A flash LiDAR can transmit laser light to simultaneously illuminate an FOV using a single light pulse or light shot.

A LiDAR system is a frequently-used sensor of a vehicle that is at least partially automated. In one embodiment, as shown in FIG. 1, motor vehicle 100 may include a single LiDAR system 110 (e.g., without LiDAR systems 120A-120I) disposed at the highest position of the vehicle (e.g., at the vehicle roof). Disposing LiDAR system 110 at the vehicle roof facilitates a 360-degree scanning around vehicle 100. In some other embodiments, motor vehicle 100 can include multiple LiDAR systems, including two or more of systems 110 and/or 120A-120I. As shown in FIG. 1, in one embodiment, multiple LiDAR systems 110 and/or 120A-120I are attached to vehicle 100 at different locations of the vehicle. For example, LiDAR system 120A is attached to vehicle 100 at the front right corner; LiDAR system 120B is attached to vehicle 100 at the front center position; LiDAR system 120C is attached to vehicle 100 at the front left corner; LiDAR system 120D is attached to vehicle 100 at the right-side rear view mirror; LiDAR system 120E is attached to vehicle 100 at the left-side rear view mirror; LiDAR system 120F is attached to vehicle 100 at the back center position; LiDAR system 120G is attached to vehicle 100 at the back right corner; LiDAR system 120H is attached to vehicle 100 at the back left corner; and/or LiDAR system 120I is attached to vehicle 100 at the center towards the backend (e.g., back end of the vehicle roof). It is understood that one or more LiDAR systems can be distributed and attached to a vehicle in any desired manner and FIG. 1 only illustrates one embodiment. As another example, LiDAR systems 120D and 120E may be attached to the B-pillars of vehicle 100 instead of the rear-view mirrors. As another example, LiDAR system 120B may be attached to the windshield of vehicle 100 instead of the front bumper.

In some embodiments, LiDAR systems 110 and 120A-120I are independent LiDAR systems having their own respective laser sources, control electronics, transmitters, receivers, and/or steering mechanisms. In other embodiments, some of LiDAR systems 110 and 120A-120I can share one or more components, thereby forming a distributed sensor system. In one example, optical fibers are used to deliver laser light from a centralized laser source to all LiDAR systems. For instance, system 110 (or another system that is centrally positioned or positioned anywhere inside the vehicle 100) includes a light source, a transmitter, and a light detector, but have no steering mechanisms. System 110 may distribute transmission light to each of systems 120A-120I. The transmission light may be distributed via optical fibers. Optical connectors can be used to couple the optical fibers to each of system 110 and 120A-120I. In some examples, one or more of systems 120A-120I include steering mechanisms but no light sources, transmitters, or light detectors. A steering mechanism may include one or more moveable mirrors such as one or more polygon mirrors, one or more single plane mirrors, one or more multi-plane mirrors, or the like. Embodiments of the light source, transmitter, steering mechanism, and light detector are described in more detail below. Via the steering mechanisms, one or more of systems 120A-120I scan light into one or more respective FOVs and receive corresponding return light. The return light is formed by scattering or reflecting the transmission light by one or more objects in the FOVs. Systems 120A-120I may also include collection lens and/or other optics to focus and/or direct the return light into optical fibers, which deliver the received return light to system 110. System 110 includes one or more light detectors for detecting the received return light. In some examples, system 110 is disposed inside a vehicle such that it is in a temperature-controlled environment, while one or more systems 120A-120I may be at least partially exposed to the external environment.

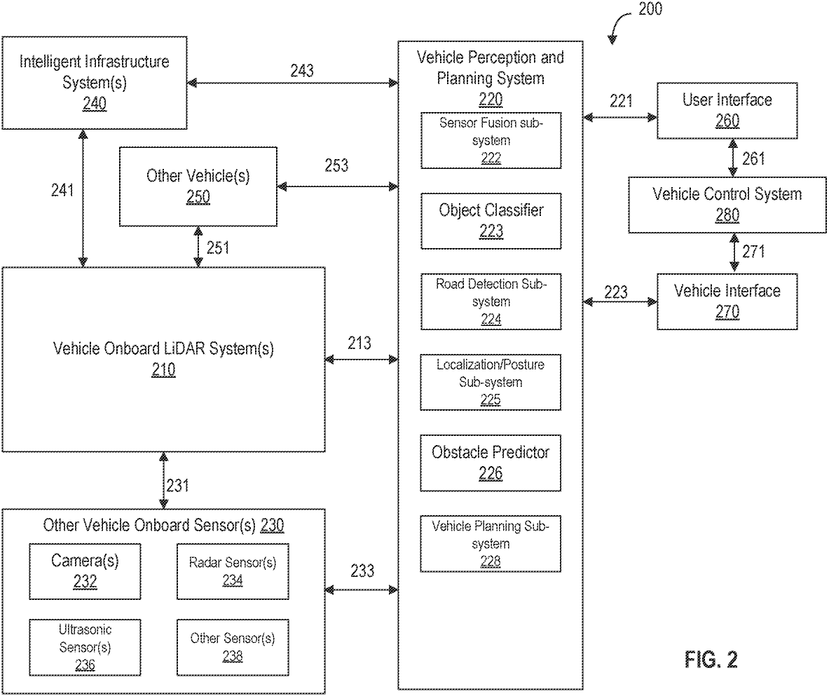

FIG. 2 is a block diagram 200 illustrating interactions between vehicle onboard LiDAR system(s) 210 and multiple other systems including a vehicle perception and planning system 220. LiDAR system(s) 210 can be mounted on or integrated to a vehicle. LiDAR system(s) 210 include sensor(s) that scan laser light to the surrounding environment to measure the distance, angle, and/or velocity of objects. Based on the scattered light that returned to LiDAR system(s) 210, it can generate sensor data (e.g., image data or 3D point cloud data) representing the perceived external environment.

LiDAR system(s) 210 can include one or more of short-range LiDAR sensors, medium-range LiDAR sensors, and long-range LiDAR sensors. A short-range LiDAR sensor measures objects located up to about 20-50 meters from the LiDAR sensor. Short-range LiDAR sensors can be used for, e.g., monitoring nearby moving objects (e.g., pedestrians crossing street in a school zone), parking assistance applications, or the like. A medium-range LiDAR sensor measures objects located up to about 70-200 meters from the LiDAR sensor. Medium-range LiDAR sensors can be used for, e.g., monitoring road intersections, assistance for merging onto or leaving a freeway, or the like. A long-range LiDAR sensor measures objects located up to about 200 meters and beyond. Long-range LiDAR sensors are typically used when a vehicle is travelling at a high speed (e.g., on a freeway), such that the vehicle’s control systems may only have a few seconds (e.g., 6-8 seconds) to respond to any situations detected by the LiDAR sensor. As shown in FIG. 2, in one embodiment, the LiDAR sensor data can be provided to vehicle perception and planning system 220 via a communication path 213 for further processing and controlling the vehicle operations. Communication path 213 can be any wired or wireless communication links that can transfer data.

With reference still to FIG. 2, in some embodiments, other vehicle onboard sensor(s) 230 are configured to provide additional sensor data separately or together with LiDAR system(s) 210. Other vehicle onboard sensors 230 may include, for example, one or more camera(s) 232, one or more radar(s) 234, one or more ultrasonic sensor(s) 236, and/or other sensor(s) 238. Camera(s) 232 can take images and/or videos of the external environment of a vehicle. Camera(s) 232 can take, for example, high-definition (HD) videos having millions of pixels in each frame. A camera includes image sensors that facilitates producing monochrome or color images and videos. Color information may be important in interpreting data for some situations (e.g., interpreting images of traffic lights). Color information may not be available from other sensors such as LiDAR or radar sensors. Camera(s) 232 can include one or more of narrow-focus cameras, wider-focus cameras, side-facing cameras, infrared cameras, fisheye cameras, or the like. The image and/or video data generated by camera(s) 232 can also be provided to vehicle perception and planning system 220 via communication path 233 for further processing and controlling the vehicle operations. Communication path 233 can be any wired or wireless communication links that can transfer data. Camera(s) 232 can be mount on, or integrated to, a vehicle at any locations (e.g., rear-view mirrors, pillars, front grille, and/or back bumpers, etc.).

Other vehicle onboard sensos(s) 230 can also include radar sensor(s) 234. Radar sensor(s) 234 use radio waves to determine the range, angle, and velocity of objects. Radar sensor(s) 234 produce electromagnetic waves in the radio or microwave spectrum. The electromagnetic waves reflect off an object and some of the reflected waves return to the radar sensor, thereby providing information about the object’s position and velocity. Radar sensor(s) 234 can include one or more of short-range radar(s), medium-range radar(s), and long-range radar(s). A short-range radar measures objects located at about 0.1-30 meters from the radar. A short-range radar is useful in detecting objects located nearby the vehicle, such as other vehicles, buildings, walls, pedestrians, bicyclists, etc. A short-range radar can be used to detect a blind spot, assist in lane changing, provide rear-end collision warning, assist in parking, provide emergency braking, or the like. A medium-range radar measures objects located at about 30-80 meters from the radar. A long-range radar measures objects located at about 80-200 meters. Medium- and/or long-range radars can be useful in, for example, traffic following, adaptive cruise control, and/or highway automatic braking. Sensor data generated by radar sensor(s) 234 can also be provided to vehicle perception and planning system 220 via communication path 233 for further processing and controlling the vehicle operations. Radar sensor(s) 234 can be mount on, or integrated to, a vehicle at any locations (e.g., rear-view mirrors, pillars, front grille, and/or back bumpers, etc.).

Other vehicle onboard sensor(s) 230 can also include ultrasonic sensor(s) 236. Ultrasonic sensor(s) 236 use acoustic waves or pulses to measure object located external to a vehicle. The acoustic waves generated by ultrasonic sensor(s) 236 are transmitted to the surrounding environment. At least some of the transmitted waves are reflected off an object and return to the ultrasonic sensor(s) 236. Based on the return signals, a distance of the object can be calculated. Ultrasonic sensor(s) 236 can be useful in, for example, checking blind spots, identifying parking spaces, providing lane changing assistance into traffic, or the like. Sensor data generated by ultrasonic sensor(s) 236 can also be provided to vehicle perception and planning system 220 via communication path 233 for further processing and controlling the vehicle operations. Ultrasonic sensor(s) 236 can be mount on, or integrated to, a vehicle at any locations (e.g., rear-view mirrors, pillars, front grille, and/or back bumpers, etc.).

In some embodiments, one or more other sensor(s) 238 may be attached in a vehicle and may also generate sensor data. Other sensor(s) 238 may include, for example, global positioning systems (GPS), inertial measurement units (IMU), or the like. Sensor data generated by other sensor(s) 238 can also be provided to vehicle perception and planning system 220 via communication path 233 for further processing and controlling the vehicle operations. It is understood that communication path 233 may include one or more communication links to transfer data between the various sensor(s) 230 and vehicle perception and planning system 220.

In some embodiments, as shown in FIG. 2, sensor data from other vehicle onboard sensor(s) 230 can be provided to vehicle onboard LiDAR system(s) 210 via communication path 231. LiDAR system(s) 210 may process the sensor data from other vehicle onboard sensor(s) 230. For example, sensor data from camera(s) 232, radar sensor(s) 234, ultrasonic sensor(s) 236, and/or other sensor(s) 238 may be correlated or fused with sensor data LiDAR system(s) 210, thereby at least partially offloading the sensor fusion process performed by vehicle perception and planning system 220. It is understood that other configurations may also be implemented for transmitting and processing sensor data from the various sensors (e.g., data can be transmitted to a cloud or edge computing service provider for processing and then the processing results can be transmitted back to the vehicle perception and planning system 220 and/or LiDAR system 210).

With reference still to FIG. 2, in some embodiments, sensors onboard other vehicle(s) 250 are used to provide additional sensor data separately or together with LiDAR system(s) 210. For example, two or more nearby vehicles may have their own respective LiDAR sensor(s), camera(s), radar sensor(s), ultrasonic sensor(s), etc. Nearby vehicles can communicate and share sensor data with one another. Communications between vehicles are also referred to as V2V (vehicle to vehicle) communications. For example, as shown in FIG. 2, sensor data generated by other vehicle(s) 250 can be communicated to vehicle perception and planning system 220 and/or vehicle onboard LiDAR system(s) 210, via communication path 253 and/or communication path 251, respectively. Communication paths 253 and 251 can be any wired or wireless communication links that can transfer data.

Sharing sensor data facilitates a better perception of the environment external to the vehicles. For instance, a first vehicle may not sense a pedestrian that is behind a second vehicle but is approaching the first vehicle. The second vehicle may share the sensor data related to this pedestrian with the first vehicle such that the first vehicle can have additional reaction time to avoid collision with the pedestrian. In some embodiments, similar to data generated by sensor(s) 230, data generated by sensors onboard other vehicle(s) 250 may be correlated or fused with sensor data generated by LiDAR system(s) 210 (or with other LiDAR systems located in other vehicles), thereby at least partially offloading the sensor fusion process performed by vehicle perception and planning system 220.

In some embodiments, intelligent infrastructure system(s) 240 are used to provide sensor data separately or together with LiDAR system(s) 210. Certain infrastructures may be configured to communicate with a vehicle to convey information and vice versa. Communications between a vehicle and infrastructures are generally referred to as V2I (vehicle to infrastructure) communications. For example, intelligent infrastructure system(s) 240 may include an intelligent traffic light that can convey its status to an approaching vehicle in a message such as “changing to yellow in 5 seconds.” Intelligent infrastructure system(s) 240 may also include its own LiDAR system mounted near an intersection such that it can convey traffic monitoring information to a vehicle. For example, a left-turning vehicle at an intersection may not have sufficient sensing capabilities because some of its own sensors may be blocked by traffic in the opposite direction. In such a situation, sensors of intelligent infrastructure system(s) 240 can provide useful data to the left-turning vehicle. Such data may include, for example, traffic conditions, information of objects in the direction the vehicle is turning to, traffic light status and predictions, or the like. These sensor data generated by intelligent infrastructure system(s) 240 can be provided to vehicle perception and planning system 220 and/or vehicle onboard LiDAR system(s) 210, via communication paths 243 and/or 241, respectively. Communication paths 243 and/or 241 can include any wired or wireless communication links that can transfer data. For example, sensor data from intelligent infrastructure system(s) 240 may be transmitted to LiDAR system(s) 210 and correlated or fused with sensor data generated by LiDAR system(s) 210, thereby at least partially offloading the sensor fusion process performed by vehicle perception and planning system 220. V2V and V2I communications described above are examples of vehicle-to-X (V2X) communications, where the “X” represents any other devices, systems, sensors, infrastructure, or the like that can share data with a vehicle.

With reference still to FIG. 2, via various communication paths, vehicle perception and planning system 220 receives sensor data from one or more of LiDAR system(s) 210, other vehicle onboard sensor(s) 230, other vehicle(s) 250, and/or intelligent infrastructure system(s) 240. In some embodiments, different types of sensor data are correlated and/or integrated by a sensor fusion sub-system 222. For example, sensor fusion sub-system 222 can generate a 360-degree model using multiple images or videos captured by multiple cameras disposed at different positions of the vehicle. Sensor fusion sub-system 222 obtains sensor data from different types of sensors and uses the combined data to perceive the environment more accurately. For example, a vehicle onboard camera 232 may not capture a clear image because it is facing the sun or a light source (e.g., another vehicle’s headlight during nighttime) directly. A LiDAR system 210 may not be affected as much and therefore sensor fusion sub-system 222 can combine sensor data provided by both camera 232 and LiDAR system 210, and use the sensor data provided by LiDAR system 210 to compensate the unclear image captured by camera 232. As another example, in a rainy or foggy weather, a radar sensor 234 may work better than a camera 232 or a LiDAR system 210. Accordingly, sensor fusion sub-system 222 may use sensor data provided by the radar sensor 234 to compensate the sensor data provided by camera 232 or LiDAR system 210.

In other examples, sensor data generated by other vehicle onboard sensor(s) 230 may have a lower resolution (e.g., radar sensor data) and thus may need to be correlated and confirmed by LiDAR system(s) 210, which usually has a higher resolution. For example, a sewage cover (also referred to as a manhole cover) may be detected by radar sensor 234 as an object towards which a vehicle is approaching. Due to the low-resolution nature of radar sensor 234, vehicle perception and planning system 220 may not be able to determine whether the object is an obstacle that the vehicle needs to avoid. High-resolution sensor data generated by LiDAR system(s) 210 thus can be used to correlated and confirm that the object is a sewage cover and causes no harm to the vehicle.

Vehicle perception and planning system 220 further comprises an object classifier 223. Using raw sensor data and/or correlated/fused data provided by sensor fusion sub-system 222, object classifier 223 can use any computer vision techniques to detect and classify the objects and estimate the positions of the objects. In some embodiments, object classifier 223 can use machine-learning based techniques to detect and classify objects. Examples of the machine-learning based techniques include utilizing algorithms such as region-based convolutional neural networks (R-CNN), Fast R-CNN, Faster R-CNN, histogram of oriented gradients (HOG), region-based fully convolutional network (R-FCN), single shot detector (SSD), spatial pyramid pooling (SPP-net), and/or You Only Look Once (Yolo).

Vehicle perception and planning system 220 further comprises a road detection sub-system 224. Road detection sub-system 224 localizes the road and identifies objects and/or markings on the road. For example, based on raw or fused sensor data provided by radar sensor(s) 234, camera(s) 232, and/or LiDAR system(s) 210, road detection sub-system 224 can build a 3D model of the road based on machine-learning techniques (e.g., pattern recognition algorithms for identifying lanes). Using the 3D model of the road, road detection sub-system 224 can identify objects (e.g., obstacles or debris on the road) and/or markings on the road (e.g., lane lines, turning marks, crosswalk marks, or the like).

Vehicle perception and planning system 220 further comprises a localization and vehicle posture sub-system 225. Based on raw or fused sensor data, localization and vehicle posture sub-system 225 can determine position of the vehicle and the vehicle’s posture. For example, using sensor data from LiDAR system(s) 210, camera(s) 232, and/or GPS data, localization and vehicle posture sub-system 225 can determine an accurate position of the vehicle on the road and the vehicle’s six degrees of freedom (e.g., whether the vehicle is moving forward or backward, up or down, and left or right). In some embodiments, high-definition (HD) maps are used for vehicle localization. HD maps can provide highly detailed, three-dimensional, computerized maps that pinpoint a vehicle’s location. For instance, using the HD maps, localization and vehicle posture sub-system 225 can determine precisely the vehicle’s current position (e.g., which lane of the road the vehicle is currently in, how close it is to a curb or a sidewalk) and predict vehicle’s future positions.

Vehicle perception and planning system 220 further comprises obstacle predictor 226. Objects identified by object classifier 223 can be stationary (e.g., a light pole, a road sign) or dynamic (e.g., a moving pedestrian, bicycle, another car). For moving objects, predicting their moving path or future positions can be important to avoid collision. Obstacle predictor 226 can predict an obstacle trajectory and/or warn the driver or the vehicle planning sub-system 228 about a potential collision. For example, if there is a high likelihood that the obstacle’s trajectory intersects with the vehicle’s current moving path, obstacle predictor 226 can generate such a warning. Obstacle predictor 226 can use a variety of techniques for making such a prediction. Such techniques include, for example, constant velocity or acceleration models, constant turn rate and velocity/acceleration models, Kalman Filter and Extended Kalman Filter based models, recurrent neural network (RNN) based models, long short-term memory (LSTM) neural network based models, encoder-decoder RNN models, or the like.

With reference still to FIG. 2, in some embodiments, vehicle perception and planning system 220 further comprises vehicle planning sub-system 228. Vehicle planning sub-system 228 can include one or more planners such as a route planner, a driving behaviors planner, and a motion planner. The route planner can plan the route of a vehicle based on the vehicle’s current location data, target location data, traffic information, etc. The driving behavior planner adjusts the timing and planned movement based on how other objects might move, using the obstacle prediction results provided by obstacle predictor 226. The motion planner determines the specific operations the vehicle needs to follow. The planning results are then communicated to vehicle control system 280 via vehicle interface 270. The communication can be performed through communication paths 223 and 271, which include any wired or wireless communication links that can transfer data.

Vehicle control system 280 controls the vehicle’s steering mechanism, throttle, brake, etc., to operate the vehicle according to the planned route and movement. In some examples, vehicle perception and planning system 220 may further comprise a user interface 260, which provides a user (e.g., a driver) access to vehicle control system 280 to, for example, override or take over control of the vehicle when necessary. User interface 260 may also be separate from vehicle perception and planning system 220. User interface 260 can communicate with vehicle perception and planning system 220, for example, to obtain and display raw or fused sensor data, identified objects, vehicle’s location/posture, etc. These displayed data can help a user to better operate the vehicle. User interface 260 can communicate with vehicle perception and planning system 220 and/or vehicle control system 280 via communication paths 221 and 261 respectively, which include any wired or wireless communication links that can transfer data. It is understood that the various systems, sensors, communication links, and interfaces in FIG. 2 can be configured in any desired manner and not limited to the configuration shown in FIG. 2.

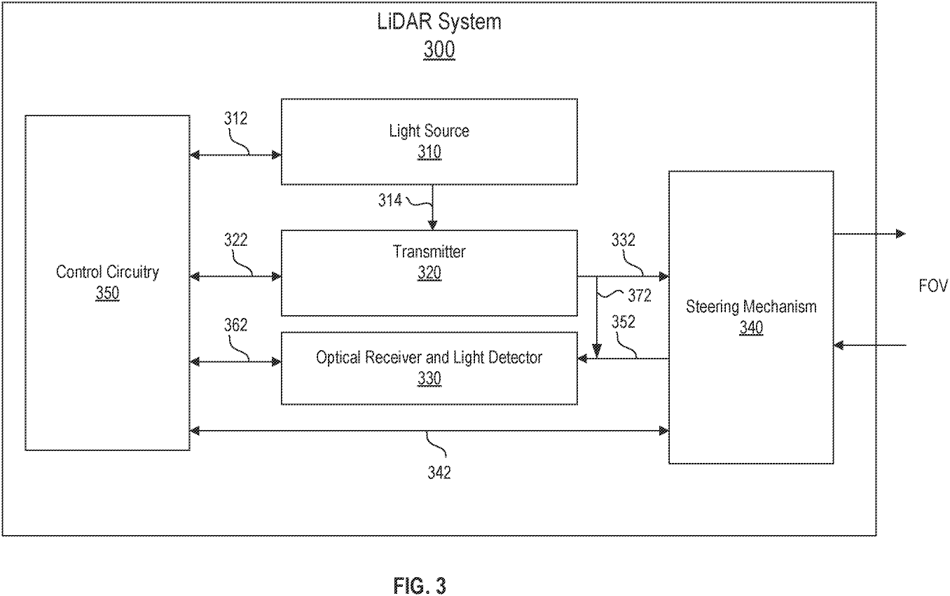

FIG. 3 is a block diagram illustrating an example LiDAR system 300. LiDAR system 300 can be used to implement LiDAR systems 110, 120A-120I, and/or 210 shown in FIGS. 1 and 2. In one embodiment, LiDAR system 300 comprises a light source 310, a transmitter 320, an optical receiver and light detector 330, a steering system 340, and a control circuitry 350. These components are coupled together using communications paths 312, 314, 322, 332, 342, 352, and 362. These communications paths include communication links (wired or wireless, bidirectional or unidirectional) among the various LiDAR system components, but need not be physical components themselves. While the communications paths can be implemented by one or more electrical wires, buses, or optical fibers, the communication paths can also be wireless channels or free-space optical paths so that no physical communication medium is present. For example, in one embodiment of LiDAR system 300, communication path 314 between light source 310 and transmitter 320 may be implemented using one or more optical fibers. Communication paths 332 and 352 may represent optical paths implemented using free space optical components and/or optical fibers. And communication paths 312, 322, 342, and 362 may be implemented using one or more electrical wires that carry electrical signals. The communications paths can also include one or more of the above types of communication mediums (e.g., they can include an optical fiber and a free-space optical component, or include one or more optical fibers and one or more electrical wires).

In some embodiments, LiDAR system 300 can be a coherent LiDAR system. One example is a frequency-modulated continuous-wave (FMCW) LiDAR. Coherent LiDARs detect objects by mixing return light from the objects with light from the coherent laser transmitter. Thus, as shown in FIG. 3, if LiDAR system 300 is a coherent LiDAR, it may include a route 372 providing a portion of transmission light from transmitter 320 to optical receiver and light detector 330. The transmission light provided by transmitter 320 may be modulated light and can be split into two portions. One portion is transmitted to the FOV, while the second portion is sent to the optical receiver and light detector of the LiDAR system. The second portion is also referred to as the light that is kept local (LO) to the LiDAR system. The transmission light is scattered or reflected by various objects in the FOV and at least a portion of it forms return light. The return light is subsequently detected and interferometrically recombined with the second portion of the transmission light that was kept local. Coherent LiDAR provides a means of optically sensing an object’s range as well as its relative velocity along the line-of-sight (LOS).

LiDAR system 300 can also include other components not depicted in FIG. 3, such as power buses, power supplies, LED indicators, switches, etc. Additionally, other communication connections among components may be present, such as a direct connection between light source 310 and optical receiver and light detector 330 to provide a reference signal so that the time from when a light pulse is transmitted until a return light pulse is detected can be accurately measured.

Light source 310 outputs laser light for illuminating objects in a field of view (FOV). The laser light can be infrared light having a wavelength in the range of 700 nm to 1 mm. Light source 310 can be, for example, a semiconductor-based laser (e.g., a diode laser) and/or a fiber-based laser. A semiconductor-based laser can be, for example, an edge emitting laser (EEL), a vertical cavity surface emitting laser (VCSEL), an external-cavity diode laser, a vertical-external-cavity surface-emitting laser, a distributed feedback (DFB) laser, a distributed Bragg reflector (DBR) laser, an interband cascade laser, a quantum cascade laser, a quantum well laser, a double heterostructure laser, or the like. A fiber-based laser is a laser in which the active gain medium is an optical fiber doped with rare-earth elements such as erbium, ytterbium, neodymium, dysprosium, praseodymium, thulium and/or holmium. In some embodiments, a fiber laser is based on double-clad fibers, in which the gain medium forms the core of the fiber surrounded by two layers of cladding. The double-clad fiber allows the core to be pumped with a high-power beam, thereby enabling the laser source to be a high power fiber laser source.

In some embodiments, light source 310 comprises a master oscillator (also referred to as a seed laser) and power amplifier (MOPA). The power amplifier amplifies the output power of the seed laser. The power amplifier can be a fiber amplifier, a bulk amplifier, or a semiconductor optical amplifier. The seed laser can be a diode laser (e.g., a Fabry-Perot cavity laser, a distributed feedback laser), a solid-state bulk laser, or a tunable external-cavity diode laser. In some embodiments, light source 310 can be an optically pumped microchip laser. Microchip lasers are alignment-free monolithic solid-state lasers where the laser crystal is directly contacted with the end mirrors of the laser resonator. A microchip laser is typically pumped with a laser diode (directly or using a fiber) to obtain the desired output power. A microchip laser can be based on neodymium-doped yttrium aluminum garnet (Y₃Al₅O₁₂) laser crystals (i.e., Nd:YAG), or neodymium-doped vanadate (i.e., ND:YVO₄) laser crystals. In some examples, light source 310 may have multiple amplification stages to achieve a high power gain such that the laser output can have high power, thereby enabling the LiDAR system to have a long scanning range. In some examples, the power amplifier of light source 310 can be controlled such that the power gain can be varied to achieve any desired laser output power.

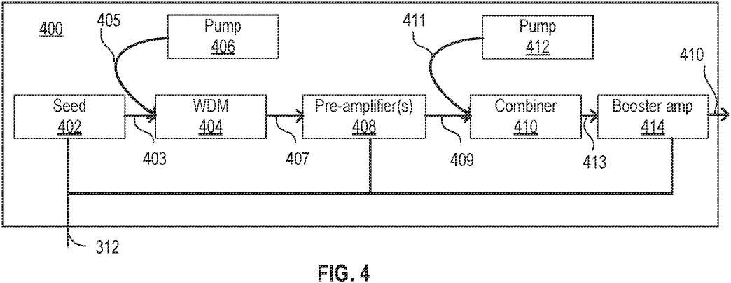

FIG. 4 is a block diagram illustrating an example fiber-based laser source 400 having a seed laser and one or more pumps (e.g., laser diodes) for pumping desired output power. Fiber-based laser source 400 is an example of light source 310 depicted in FIG. 3. In some embodiments, fiber-based laser source 400 comprises a seed laser 402 to generate initial light pulses of one or more wavelengths (e.g., infrared wavelengths such as 1550 nm), which are provided to a wavelength-division multiplexor (WDM) 404 via an optical fiber 403. Fiber-based laser source 400 further comprises a pump 406 for providing laser power (e.g., of a different wavelength, such as 980 nm) to WDM 404 via an optical fiber 405. WDM 404 multiplexes the light pulses provided by seed laser 402 and the laser power provided by pump 406 onto a single optical fiber 407. The output of WDM 404 can then be provided to one or more pre-amplifier(s) 408 via optical fiber 407. Pre-amplifier(s) 408 can be optical amplifier(s) that amplify optical signals (e.g., with about 10-30 dB gain). In some embodiments, pre-amplifier(s) 408 are low noise amplifiers. Pre-amplifier(s) 408 output to an optical combiner 410 via an optical fiber 409. Combiner 410 combines the output laser light of pre-amplifier(s) 408 with the laser power provided by pump 412 via an optical fiber 411. Combiner 410 can combine optical signals having the same wavelength or different wavelengths. One example of a combiner is a WDM. Combiner 410 provides combined optical signals to a booster amplifier 414, which produces output light pulses via optical fiber 410. The booster amplifier 414 provides further amplification of the optical signals (e.g., another 20-40 dB). The outputted light pulses can then be transmitted to transmitter 320 and/or steering mechanism 340 (shown in FIG. 3). It is understood that FIG. 4 illustrates one example configuration of fiber-based laser source 400. Laser source 400 can have many other configurations using different combinations of one or more components shown in FIG. 4 and/or other components not shown in FIG. 4 (e.g., other components such as power supplies, lens(es), filters, splitters, combiners, etc.).

In some variations, fiber-based laser source 400 can be controlled (e.g., by control circuitry 350) to produce pulses of different amplitudes based on the fiber gain profile of the fiber used in fiber-based laser source 400. Communication path 312 couples fiber-based laser source 400 to control circuitry 350 (shown in FIG. 3) so that components of fiber-based laser source 400 can be controlled by or otherwise communicate with control circuitry 350. Alternatively, fiber-based laser source 400 may include its own dedicated controller. Instead of control circuitry 350 communicating directly with components of fiber-based laser source 400, a dedicated controller of fiber-based laser source 400 communicates with control circuitry 350 and controls and/or communicates with the components of fiber-based laser source 400. Fiber-based laser source 400 can also include other components not shown, such as one or more power connectors, power supplies, and/or power lines.

Referencing FIG. 3, typical operating wavelengths of light source 310 comprise, for example, about 850 nm, about 905 nm, about 940 nm, about 1064 nm, and about 1550 nm. For laser safety, the upper limit of maximum usable laser power is set by the U.S. FDA (U.S. Food and Drug Administration) regulations. The optical power limit at 1550 nm wavelength is much higher than those of the other aforementioned wavelengths. Further, at 1550 nm, the optical power loss in a fiber is low. There characteristics of the 1550 nm wavelength make it more beneficial for long-range LiDAR applications. The amount of optical power output from light source 310 can be characterized by its peak power, average power, pulse energy, and/or the pulse energy density. The peak power is the ratio of pulse energy to the width of the pulse (e.g., full width at half maximum or FWHM). Thus, a smaller pulse width can provide a larger peak power for a fixed amount of pulse energy. A pulse width can be in the range of nanosecond or picosecond. The average power is the product of the energy of the pulse and the pulse repetition rate (PRR). As described in more detail below, the PRR represents the frequency of the pulsed laser light. In general, the smaller the time interval between the pulses, the higher the PRR. The PRR typically corresponds to the maximum range that a LiDAR system can measure. Light source 310 can be configured to produce pulses at high PRR to meet the desired number of data points in a point cloud generated by the LiDAR system. Light source 310 can also be configured to produce pulses at medium or low PRR to meet the desired maximum detection distance. Wall plug efficiency (WPE) is another factor to evaluate the total power consumption, which may be a useful indicator in evaluating the laser efficiency. For example, as shown in FIG. 1, multiple LiDAR systems may be attached to a vehicle, which may be an electrical-powered vehicle or a vehicle otherwise having limited fuel or battery power supply. Therefore, high WPE and intelligent ways to use laser power are often among the important considerations when selecting and configuring light source 310 and/or designing laser delivery systems for vehicle-mounted LiDAR applications.

It is understood that the above descriptions provide non-limiting examples of a light source 310. Light source 310 can be configured to include many other types of light sources (e.g., laser diodes, short-cavity fiber lasers, solid-state lasers, and/or tunable external cavity diode lasers) that are configured to generate one or more light signals at various wavelengths. In some examples, light source 310 comprises amplifiers (e.g., pre-amplifiers and/or booster amplifiers), which can be a doped optical fiber amplifier, a solid-state bulk amplifier, and/or a semiconductor optical amplifier. The amplifiers are configured to receive and amplify light signals with desired gains.

With reference back to FIG. 3, LiDAR system 300 further comprises a transmitter 320. Light source 310 provides laser light (e.g., in the form of a laser beam) to transmitter 320. The laser light provided by light source 310 can be amplified laser light with a predetermined or controlled wavelength, pulse repetition rate, and/or power level. Transmitter 320 receives the laser light from light source 310 and transmits the laser light to steering mechanism 340 with low divergence. In some embodiments, transmitter 320 can include, for example, optical components (e.g., lens, fibers, mirrors, etc.) for transmitting one or more laser beams to a field-of-view (FOV) directly or via steering mechanism 340. While FIG. 3 illustrates transmitter 320 and steering mechanism 340 as separate components, they may be combined or integrated as one system in some embodiments. Steering mechanism 340 is described in more detail below.

Laser beams provided by light source 310 may diverge as they travel to transmitter 320. Therefore, transmitter 320 often comprises a collimating lens configured to collect the diverging laser beams and produce more parallel optical beams with reduced or minimum divergence. The collimated optical beams can then be further directed through various optics such as mirrors and lens. A collimating lens may be, for example, a single plano-convex lens or a lens group. The collimating lens can be configured to achieve any desired properties such as the beam diameter, divergence, numerical aperture, focal length, or the like. A beam propagation ratio or beam quality factor (also referred to as the M² factor) is used for measurement of laser beam quality. In many LiDAR applications, it is important to have good laser beam quality in the generated transmitting laser beam. The M² factor represents a degree of variation of a beam from an ideal Gaussian beam. Thus, the M² factor reflects how well a collimated laser beam can be focused on a small spot, or how well a divergent laser beam can be collimated. Therefore, light source 310 and/or transmitter 320 can be configured to meet, for example, a scan resolution requirement while maintaining the desired M² factor.

One or more of the light beams provided by transmitter 320 are scanned by steering mechanism 340 to a FOV. Steering mechanism 340 scans light beams in multiple dimensions (e.g., in both the horizontal and vertical dimension) to facilitate LiDAR system 300 to map the environment by generating a 3D point cloud. A horizontal dimension can be a dimension that is parallel to the horizon or a surface associated with the LiDAR system or a vehicle (e.g., a road surface). A vertical dimension is perpendicular to the horizontal dimension (i.e., the vertical dimension forms a 90-degree angle with the horizontal dimension). Steering mechanism 340 will be described in more detail below. The laser light scanned to an FOV may be scattered or reflected by an object in the FOV. At least a portion of the scattered or reflected light forms return light that returns to LiDAR system 300. FIG. 3 further illustrates an optical receiver and light detector 330 configured to receive the return light. Optical receiver and light detector 330 comprises an optical receiver that is configured to collect the return light from the FOV. The optical receiver can include optics (e.g., lens, fibers, mirrors, etc.) for receiving, redirecting, focusing, amplifying, and/or filtering return light from the FOV. For example, the optical receiver often includes a collection lens (e.g., a single plano-convex lens or a lens group) to collect and/or focus the collected return light onto a light detector.

A light detector detects the return light focused by the optical receiver and generates current and/or voltage signals proportional to the incident intensity of the return light. Based on such current and/or voltage signals, the depth information of the object in the FOV can be derived. One example method for deriving such depth information is based on the direct TOF (time of flight), which is described in more detail below. A light detector may be characterized by its detection sensitivity, quantum efficiency, detector bandwidth, linearity, signal to noise ratio (SNR), overload resistance, interference immunity, etc. Based on the applications, the light detector can be configured or customized to have any desired characteristics. For example, optical receiver and light detector 330 can be configured such that the light detector has a large dynamic range while having a good linearity. The light detector linearity indicates the detector’s capability of maintaining linear relationship between input optical signal power and the detector’s output. A detector having good linearity can maintain a linear relationship over a large dynamic input optical signal range.

To achieve desired detector characteristics, configurations or customizations can be made to the light detector’s structure and/or the detector’s material system. Various detector structure can be used for a light detector. For example, a light detector structure can be a PIN based structure, which has a undoped intrinsic semiconductor region (i.e., an “i” region) between a p-type semiconductor and an n-type semiconductor region. Other light detector structures comprise, for example, an APD (avalanche photodiode) based structure, a PMT (photomultiplier tube) based structure, a SiPM (Silicon photomultiplier) based structure, a SPAD (single-photon avalanche diode) based structure, and/or quantum wires. For material systems used in a light detector, Si, InGaAs, and/or Si/Ge based materials can be used. It is understood that many other detector structures and/or material systems can be used in optical receiver and light detector 330.

A light detector (e.g., an APD based detector) may have an internal gain such that the input signal is amplified when generating an output signal. However, noise may also be amplified due to the light detector’s internal gain. Common types of noise include signal shot noise, dark current shot noise, thermal noise, and amplifier noise. In some embodiments, optical receiver and light detector 330 may include a pre-amplifier that is a low noise amplifier (LNA). In some embodiments, the pre-amplifier may also include a transimpedance amplifier (TIA), which converts a current signal to a voltage signal. For a linear detector system, input equivalent noise or noise equivalent power (NEP) measures how sensitive the light detector is to weak signals. Therefore, they can be used as indicators of the overall system performance. For example, the NEP of a light detector specifies the power of the weakest signal that can be detected and therefore it in turn specifies the maximum range of a LiDAR system. It is understood that various light detector optimization techniques can be used to meet the requirement of LiDAR system 300. Such optimization techniques may include selecting different detector structures, materials, and/or implementing signal processing techniques (e.g., filtering, noise reduction, amplification, or the like). For example, in addition to, or instead of, using direct detection of return signals (e.g., by using ToF), coherent detection can also be used for a light detector. Coherent detection allows for detecting amplitude and phase information of the received light by interfering the received light with a local oscillator. Coherent detection can improve detection sensitivity and noise immunity.

FIG. 3 further illustrates that LiDAR system 300 comprises steering mechanism 340. As described above, steering mechanism 340 directs light beams from transmitter 320 to scan an FOV in multiple dimensions. A steering mechanism is referred to as a raster mechanism, a scanning mechanism, or simply a light scanner. Scanning light beams in multiple directions (e.g., in both the horizontal and vertical directions) facilitates a LiDAR system to map the environment by generating an image or a 3D point cloud. A steering mechanism can be based on mechanical scanning and/or solid-state scanning. Mechanical scanning uses rotating mirrors to steer the laser beam or physically rotate the LiDAR transmitter and receiver (collectively referred to as transceiver) to scan the laser beam. Solid-state scanning directs the laser beam to various positions through the FOV without mechanically moving any macroscopic components such as the transceiver. Solid-state scanning mechanisms include, for example, optical phased arrays based steering and flash LiDAR based steering. In some embodiments, because solid-state scanning mechanisms do not physically move macroscopic components, the steering performed by a solid-state scanning mechanism may be referred to as effective steering. A LiDAR system using solid-state scanning may also be referred to as a non-mechanical scanning or simply non-scanning LiDAR system (a flash LiDAR system is an example non-scanning LiDAR system).

Steering mechanism 340 can be used with a transceiver (e.g., transmitter 320 and optical receiver and light detector 330) to scan the FOV for generating an image or a 3D point cloud. As an example, to implement steering mechanism 340, a two-dimensional mechanical scanner can be used with a single-point or several single-point transceivers. A single-point transceiver transmits a single light beam or a small number of light beams (e.g., 2-8 beams) to the steering mechanism. A two-dimensional mechanical steering mechanism comprises, for example, polygon mirror(s), oscillating mirror(s), rotating prism(s), rotating tilt mirror surface(s), single-plane or multi-plane mirror(s), or a combination thereof. In some embodiments, steering mechanism 340 may include non-mechanical steering mechanism(s) such as solid-state steering mechanism(s). For example, steering mechanism 340 can be based on tuning wavelength of the laser light combined with refraction effect, and/or based on reconfigurable grating/phase array. In some embodiments, steering mechanism 340 can use a single scanning device to achieve two-dimensional scanning or multiple scanning devices combined to realize two-dimensional scanning.

As another example, to implement steering mechanism 340, a one-dimensional mechanical scanner can be used with an array or a large number of single-point transceivers. Specifically, the transceiver array can be mounted on a rotating platform to achieve 360-degree horizontal field of view. Alternatively, a static transceiver array can be combined with the one-dimensional mechanical scanner. A one-dimensional mechanical scanner comprises polygon mirror(s), oscillating mirror(s), rotating prism(s), rotating tilt mirror surface(s), or a combination thereof, for obtaining a forward-looking horizontal field of view. Steering mechanisms using mechanical scanners can provide robustness and reliability in high volume production for automotive applications.

As another example, to implement steering mechanism 340, a two-dimensional transceiver can be used to generate a scan image or a 3D point cloud directly. In some embodiments, a stitching or micro shift method can be used to improve the resolution of the scan image or the field of view being scanned. For example, using a two-dimensional transceiver, signals generated at one direction (e.g., the horizontal direction) and signals generated at the other direction (e.g., the vertical direction) may be integrated, interleaved, and/or matched to generate a higher or full resolution image or 3D point cloud representing the scanned FOV.

Some implementations of steering mechanism 340 comprise one or more optical redirection elements (e.g., mirrors or lenses) that steer return light signals (e.g., by rotating, vibrating, or directing) along a receive path to direct the return light signals to optical receiver and light detector 330. The optical redirection elements that direct light signals along the transmitting and receiving paths may be the same components (e.g., shared), separate components (e.g., dedicated), and/or a combination of shared and separate components. This means that in some cases the transmitting and receiving paths are different although they may partially overlap (or in some cases, substantially overlap or completely overlap).

With reference still to FIG. 3, LiDAR system 300 further comprises control circuitry 350. Control circuitry 350 can be configured and/or programmed to control various parts of the LiDAR system 300 and/or to perform signal processing. In a typical system, control circuitry 350 can be configured and/or programmed to perform one or more control operations including, for example, controlling light source 310 to obtain the desired laser pulse timing, the pulse repetition rate, and power; controlling steering mechanism 340 (e.g., controlling the speed, direction, and/or other parameters) to scan the FOV and maintain pixel registration and /or alignment; controlling optical receiver and light detector 330 (e.g., controlling the sensitivity, noise reduction, filtering, and/or other parameters) such that it is an optimal state; and monitoring overall system health/status for functional safety (e.g., monitoring the laser output power and/or the steering mechanism operating status for safety).

Control circuitry 350 can also be configured and/or programmed to perform signal processing to the raw data generated by optical receiver and light detector 330 to derive distance and reflectance information, and perform data packaging and communication to vehicle perception and planning system 220 (shown in FIG. 2). For example, control circuitry 350 determines the time it takes from transmitting a light pulse until a corresponding return light pulse is received; determines when a return light pulse is not received for a transmitted light pulse; determines the direction (e.g., horizontal and/or vertical information) for a transmitted/return light pulse; determines the estimated range in a particular direction; derives the reflectivity of an object in the FOV, and/or determines any other type of data relevant to LiDAR system 300.

LiDAR system 300 can be disposed in a vehicle, which may operate in many different environments including hot or cold weather, rough road conditions that may cause intense vibration, high or low humidities, dusty areas, etc. Therefore, in some embodiments, optical and/or electronic components of LiDAR system 300 (e.g., optics in transmitter 320, optical receiver and light detector 330, and steering mechanism 340) are disposed and/or configured in such a manner to maintain long term mechanical and optical stability. For example, components in LiDAR system 300 may be secured and sealed such that they can operate under all conditions a vehicle may encounter. As an example, an anti-moisture coating and/or hermetic sealing may be applied to optical components of transmitter 320, optical receiver and light detector 330, and steering mechanism 340 (and other components that are susceptible to moisture). As another example, housing(s), enclosure(s), fairing(s), and/or window can be used in LiDAR system 300 for providing desired characteristics such as hardness, ingress protection (IP) rating, self-cleaning capability, resistance to chemical and resistance to impact, or the like. In addition, efficient and economical methodologies for assembling LiDAR system 300 may be used to meet the LiDAR operating requirements while keeping the cost low.

It is understood by a person of ordinary skill in the art that FIG. 3 and the above descriptions are for illustrative purposes only, and a LiDAR system can include other functional units, blocks, or segments, and can include variations or combinations of these above functional units, blocks, or segments. For example, LiDAR system 300 can also include other components not depicted in FIG. 3, such as power buses, power supplies, LED indicators, switches, etc. Additionally, other connections among components may be present, such as a direct connection between light source 310 and optical receiver and light detector 330 so that light detector 330 can accurately measure the time from when light source 310 transmits a light pulse until light detector 330 detects a return light pulse.

These components shown in FIG. 3 are coupled together using communications paths 312, 314, 322, 332, 342, 352, and 362. These communications paths represent communication (bidirectional or unidirectional) among the various LiDAR system components but need not be physical components themselves. While the communications paths can be implemented by one or more electrical wires, busses, or optical fibers, the communication paths can also be wireless channels or open-air optical paths so that no physical communication medium is present. For example, in one example LiDAR system, communication path 314 includes one or more optical fibers; communication path 352 represents an optical path; and communication paths 312, 322, 342, and 362 are all electrical wires that carry electrical signals. The communication paths can also include more than one of the above types of communication mediums (e.g., they can include an optical fiber and an optical path, or one or more optical fibers and one or more electrical wires).

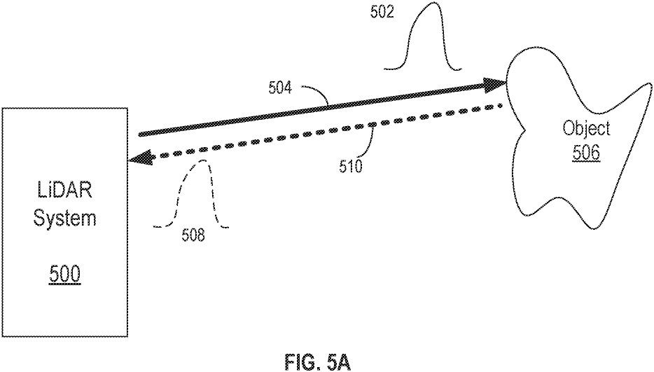

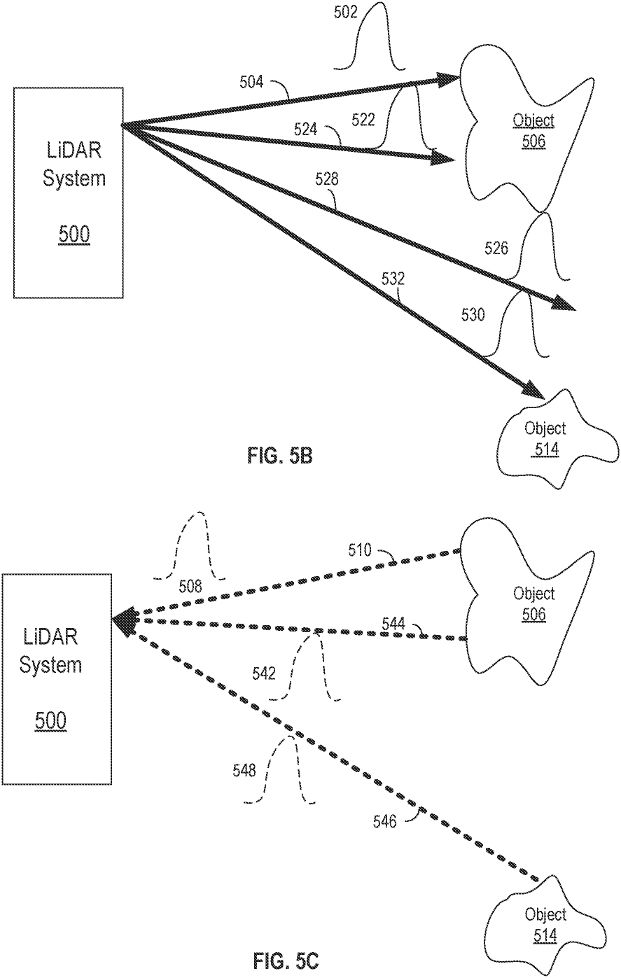

As described above, some LiDAR systems use the time-of-flight (ToF) of light signals (e.g., light pulses) to determine the distance to objects in a light path. For example, with reference to FIG. 5A, an example LiDAR system 500 includes a laser light source (e.g., a fiber laser), a steering mechanism (e.g., a system of one or more moving mirrors), and a light detector (e.g., a photodetector with one or more optics). LiDAR system 500 can be implemented using, for example, LiDAR system 300 described above. LiDAR system 500 transmits a light pulse 502 along light path 504 as determined by the steering mechanism of LiDAR system 500. In the depicted example, light pulse 502, which is generated by the laser light source, is a short pulse of laser light. Further, the signal steering mechanism of the LiDAR system 500 is a pulsed-signal steering mechanism. However, it should be appreciated that LiDAR systems can operate by generating, transmitting, and detecting light signals that are not pulsed and derive ranges to an object in the surrounding environment using techniques other than time-of-flight. For example, some LiDAR systems use frequency modulated continuous waves (i.e., “FMCW”). It should be further appreciated that any of the techniques described herein with respect to time-of-flight based systems that use pulsed signals also may be applicable to LiDAR systems that do not use one or both of these techniques.

Referring back to FIG. 5A (e.g., illustrating a time-of-flight LiDAR system that uses light pulses), when light pulse 502 reaches object 506, light pulse 502 scatters or reflects to form a return light pulse 508. Return light pulse 508 may return to system 500 along light path 510. The time from when transmitted light pulse 502 leaves LiDAR system 500 to when return light pulse 508 arrives back at LiDAR system 500 can be measured (e.g., by a processor or other electronics, such as control circuitry 350, within the LiDAR system). This time-of-flight combined with the knowledge of the speed of light can be used to determine the range/distance from LiDAR system 500 to the portion of object 506 where light pulse 502 scattered or reflected.

By directing many light pulses, as depicted in FIG. 5B, LiDAR system 500 scans the external environment (e.g., by directing light pulses 502, 522, 526, 530 along light paths 504, 524, 528, 532, respectively). As depicted in FIG. 5C, LiDAR system 500 receives return light pulses 508, 542, 548 (which correspond to transmitted light pulses 502, 522, 530, respectively). Return light pulses 508, 542, and 548 are formed by scattering or reflecting the transmitted light pulses by one of objects 506 and 514. Return light pulses 508, 542, and 548 may return to LiDAR system 500 along light paths 510, 544, and 546, respectively. Based on the direction of the transmitted light pulses (as determined by LiDAR system 500) as well as the calculated range from LiDAR system 500 to the portion of objects that scatter or reflect the light pulses (e.g., the portions of objects 506 and 514), the external environment within the detectable range (e.g., the field of view between path 504 and 532, inclusively) can be precisely mapped or plotted (e.g., by generating a 3D point cloud or images).

If a corresponding light pulse is not received for a particular transmitted light pulse, then LiDAR system 500 may determine that there are no objects within a detectable range of LiDAR system 500 (e.g., an object is beyond the maximum scanning distance of LiDAR system 500). For example, in FIG. 5B, light pulse 526 may not have a corresponding return light pulse (as illustrated in FIG. 5C) because light pulse 526 may not produce a scattering event along its transmission path 528 within the predetermined detection range. LiDAR system 500, or an external system in communication with LiDAR system 500 (e.g., a cloud system or service), can interpret the lack of return light pulse as no object being disposed along light path 528 within the detectable range of LiDAR system 500.

In FIG. 5B, light pulses 502, 522, 526, and 530 can be transmitted in any order, serially, in parallel, or based on other timings with respect to each other. Additionally, while FIG. 5B depicts transmitted light pulses as being directed in one dimension or one plane (e.g., the plane of the paper), LiDAR system 500 can also direct transmitted light pulses along other dimension(s) or plane(s). For example, LiDAR system 500 can also direct transmitted light pulses in a dimension or plane that is perpendicular to the dimension or plane shown in FIG. 5B, thereby forming a 2-dimensional transmission of the light pulses. This 2-dimensional transmission of the light pulses can be point-by-point, line-by-line, all at once, or in some other manner. That is, LiDAR system 500 can be configured to perform a point scan, a line scan, a one-shot without scanning, or a combination thereof. A point cloud or image from a 1-dimensional transmission of light pulses (e.g., a single horizontal line) can generate 2-dimensional data (e.g., (1) data from the horizontal transmission direction and (2) the range or distance to objects). Similarly, a point cloud or image from a 2-dimensional transmission of light pulses can generate 3-dimensional data (e.g., (1) data from the horizontal transmission direction, (2) data from the vertical transmission direction, and (3) the range or distance to objects). In general, a LiDAR system performing an n-dimensional transmission of light pulses generates (n+1) dimensional data. This is because the LiDAR system can measure the depth of an object or the range/distance to the object, which provides the extra dimension of data. Therefore, a 2D scanning by a LiDAR system can generate a 3D point cloud for mapping the external environment of the LiDAR system.

The density of a point cloud refers to the number of measurements (data points) per area performed by the LiDAR system. A point cloud density relates to the LiDAR scanning resolution. Typically, a larger point cloud density, and therefore a higher resolution, is desired at least for the region of interest (ROI). The density of points in a point cloud or image generated by a LiDAR system is equal to the number of pulses divided by the field of view. In some embodiments, the field of view can be fixed. Therefore, to increase the density of points generated by one set of transmission-receiving optics (or transceiver optics), the LiDAR system may need to generate a pulse more frequently. In other words, a light source in the LiDAR system may have a higher pulse repetition rate (PRR). On the other hand, by generating and transmitting pulses more frequently, the farthest distance that the LiDAR system can detect may be limited. For example, if a return signal from a distant object is received after the system transmits the next pulse, the return signals may be detected in a different order than the order in which the corresponding signals are transmitted, thereby causing ambiguity if the system cannot correctly correlate the return signals with the transmitted signals.

To illustrate, consider an example LiDAR system that can transmit laser pulses with a pulse repetition rate between 500 kHz and 1 MHz. Based on the time it takes for a pulse to return to the LiDAR system and to avoid mix-up of return pulses from consecutive pulses in a typical LiDAR design, the farthest distance the LiDAR system can detect may be 300 meters and 150 meters for 500 kHz and 1 MHz, respectively. The density of points of a LiDAR system with 500 kHz repetition rate is half of that with 1 MHz. Thus, this example demonstrates that, if the system cannot correctly correlate return signals that arrive out of order, increasing the repetition rate from 500 kHz to 1 MHz (and thus improving the density of points of the system) may reduce the detection range of the system. Various techniques are used to mitigate the tradeoff between higher PRR and limited detection range. For example, multiple wavelengths can be used for detecting objects in different ranges. Optical and/or signal processing techniques (e.g., pulse encoding techniques) are also used to correlate between transmitted and return light signals.

Various systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Various systems, apparatus, and methods described herein may be implemented using computers operating in a client-server relationship. Typically, in such a system, the client computers are located remotely from the server computers and interact via a network. The client-server relationship may be defined and controlled by computer programs running on the respective client and server computers. Examples of client computers can include desktop computers, workstations, portable computers, cellular smartphones, tablets, or other types of computing devices.

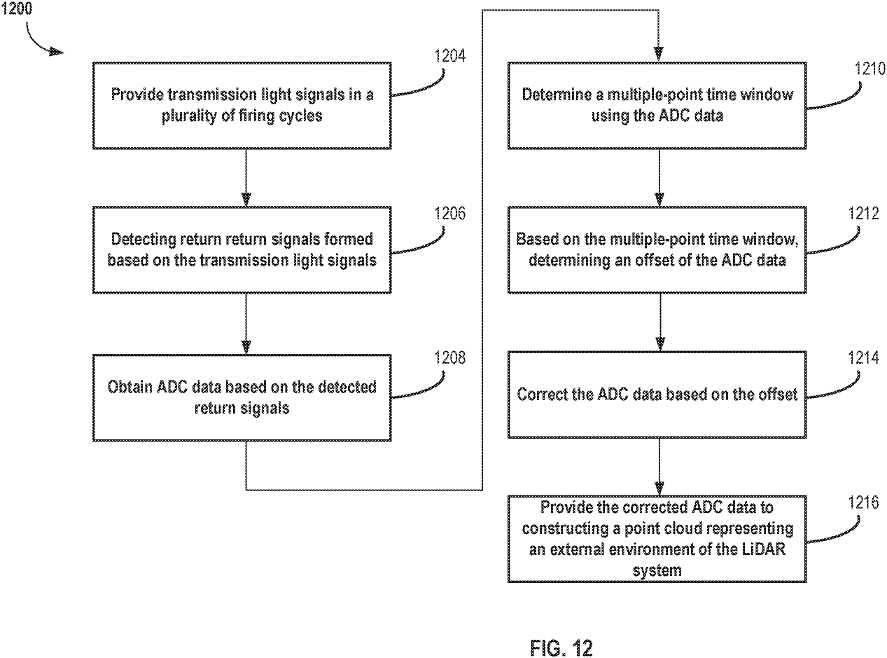

Various systems, apparatus, and methods described herein may be implemented using a computer program product tangibly embodied in an information carrier, e.g., in a non-transitory machine-readable storage device, for execution by a programmable processor; and the method processes and steps described herein, including one or more of the steps of at least some of the FIGS. 12-14, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

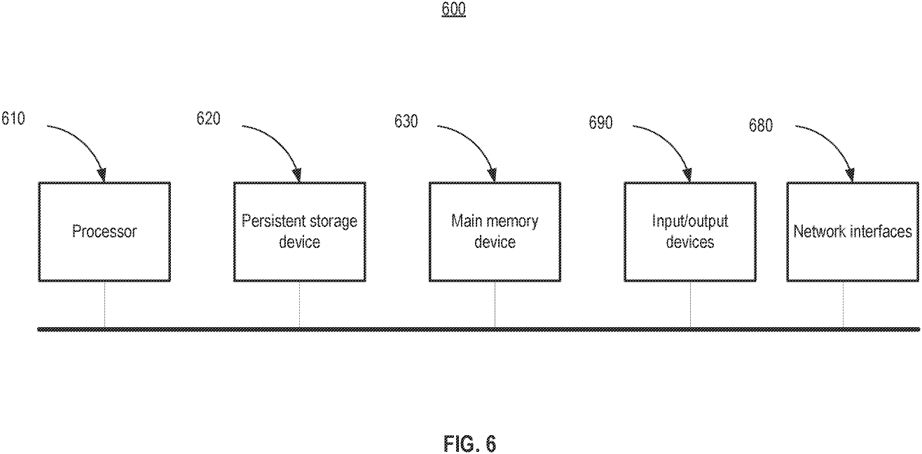

A high-level block diagram of an example apparatus that may be used to implement systems, apparatus and methods described herein is illustrated in FIG. 6. Apparatus 600 comprises a processor 610 operatively coupled to a persistent storage device 620 and a main memory device 630. Processor 610 controls the overall operation of apparatus 600 by executing computer program instructions that define such operations. The computer program instructions may be stored in persistent storage device 620, or other computer-readable medium, and loaded into main memory device 630 when execution of the computer program instructions is desired. For example, processor 610 may be used to implement one or more components and systems described herein, such as control circuitry 350 (shown in FIG. 3), vehicle perception and planning system 220 (shown in FIG. 2), and vehicle control system 280 (shown in FIG. 2). Thus, the method steps of at least some of FIGS. 12-14 can be defined by the computer program instructions stored in main memory device 630 and/or persistent storage device 620 and controlled by processor 610 executing the computer program instructions. For example, the computer program instructions can be implemented as computer executable code programmed by one skilled in the art to perform an algorithm defined by the method steps discussed herein in connection with at least some of FIGS. 12-14. Accordingly, by executing the computer program instructions, the processor 610 executes an algorithm defined by the method steps of these aforementioned figures. Apparatus 600 also includes one or more network interfaces 680 for communicating with other devices via a network. Apparatus 600 may also include one or more input/output devices 690 that enable user interaction with apparatus 600 (e.g., display, keyboard, mouse, speakers, buttons, etc.).

Processor 610 may include both general and special purpose microprocessors and may be the sole processor or one of multiple processors of apparatus 600. Processor 610 may comprise one or more central processing units (CPUs), and one or more graphics processing units (GPUs), which, for example, may work separately from and/or multi-task with one or more CPUs to accelerate processing, e.g., for various image processing applications described herein. Processor 610, persistent storage device 620, and/or main memory device 630 may include, be supplemented by, or incorporated in, one or more application-specific integrated circuits (ASICs) and/or one or more field programmable gate arrays (FPGAs).

Persistent storage device 620 and main memory device 630 each comprise a tangible non-transitory computer readable storage medium. Persistent storage device 620, and main memory device 630, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 690 may include peripherals, such as a printer, scanner, display screen, etc. For example, input/output devices 690 may include a display device such as a cathode ray tube (CRT), plasma or liquid crystal display (LCD) monitor for displaying information to a user, a keyboard, and a pointing device such as a mouse or a trackball by which the user can provide input to apparatus 600.

Any or all of the functions of the systems and apparatuses discussed herein may be performed by processor 610, and/or incorporated in, an apparatus or a system such as LiDAR system 300. Further, LiDAR system 300 and/or apparatus 600 may utilize one or more neural networks or other deep-learning techniques performed by processor 610 or other systems or apparatuses discussed herein.

One skilled in the art will recognize that an implementation of an actual computer or computer system may have other structures and may contain other components as well, and that FIG. 6 is a high-level representation of some of the components of such a computer for illustrative purposes.

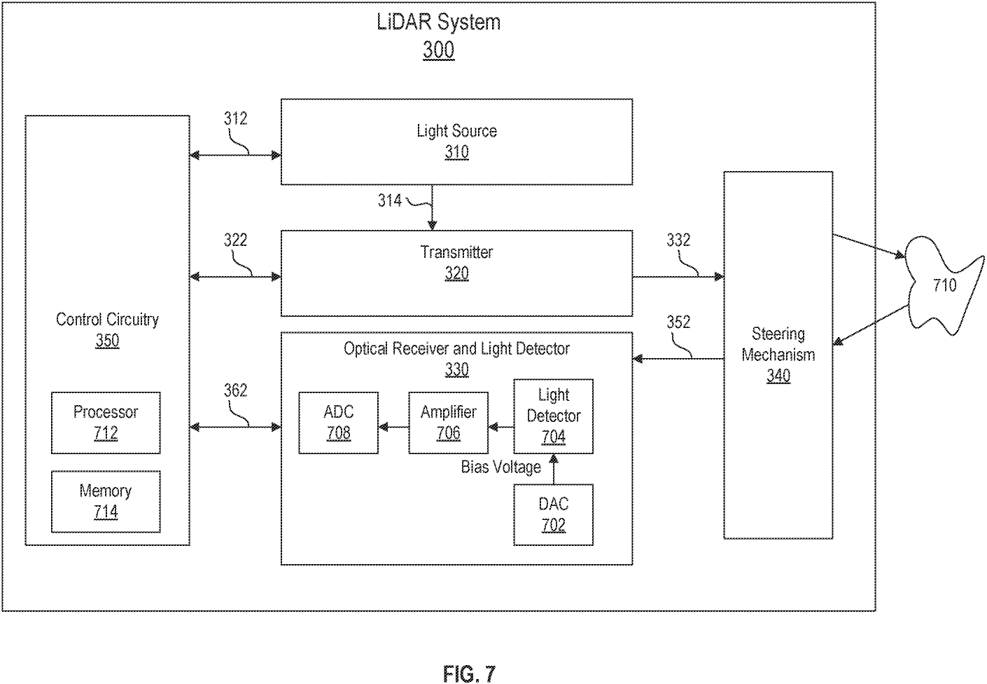

FIG. 7 is a block diagram illustrating an example LiDAR system 300 having an optical receiver and light detector 330 for detecting and processing return signals according to an embodiment. With reference to FIG. 7, in some embodiments, LiDAR system 300 includes an optical receiver and light detector 330. Optical receiver and light detector 330 includes an optical receiver (not shown), a light detector 704, an amplifier 706, an ADC 708, and a digital-to-analog converter (DAC) 702. The optical receiver is configured to collect return signals from the FOV. In some examples, the return signals are directed by steering mechanism 340 to the optical receiver via path 352. The return signals may include return light pulses formed by reflection of transmission light by object 710 in the FOV, scattered light (e.g., formed by a window of LiDAR system 300, background noise, etc.). The optical receiver can include one or more optical lenses, lens groups, mirrors, prims, or the like to receive, focus, and direct the return signals. Light detector 704 detects the return signals received by the optical receiver and generates electrical current and/or voltage signals proportional to the incident intensity of the return signals. Light detector 704 can be a charge coupled device (CCD), a photodiode, an avalanche photodiode (APD), a photomultiplier vacuum tube, or an image sensor, etc. Light detector 704 can also include filters to selectively pass light of certain wavelengths. In some examples, light detector 704 can transmit signals via communication path 362 to control circuitry 350 indicating when returned light pulses are detected. Other data related to the return light pulses, such as amplitude, power, pulse shape, and wavelength, etc., of the return light pulses may also be transmitted via communication path 362 to control circuitry 350.

With reference to FIG. 7, optical receiver and light detector 330 includes a digital-to-analog converter (DAC) 702, an amplifier 706, and an analog-to-digital converter (ADC) 708. Alternatively or additionally, optical receiver and light detector 330 may include a time-to-digital converter (TDC) instead of an ADC. DAC 702 can receive digital control signals from, e.g., control circuitry 350. Based on the digital control signals, DAC 702 generates an analog signal as a bias voltage for the light detector 704. For instance, if the light detector 704 is an APD, a bias voltage is applied across the APD to create the electric field required for avalanche multiplication to occur. If the bias voltage is f the bias voltage is too low, the APD may not provide the desired sensitivity and gain. On the other hand, if the bias voltage is too high, the APD may be damaged or its performance may be degraded due to excess noise or other factors. With the proper control of the input to DAC 702, the proper bias voltage can be selected to place the APD in its optimal operational range.

In some examples, the electrical current and/or voltage signals generated by light detector 704 are provided to amplifier 706. Amplifier 706 can amplify the signals for further processing. In one embodiment, amplifier 706 may be a transimpedance amplifier (TIA), which converts an electrical current signal generated by light detector 704 into a voltage signal, and amplifies the voltage signal to a level suitable for further processing. The output of amplifier 706 is analog signals. The analog signals are provided to ADC 708, which is configured to convert the analog signals to digital signals, which approximate the input analog signals. The output of ADC 708 are ADC data representing the detected return signals. In some examples, ADC 708 converts an analog signal to a digital signal in two stages: sampling and quantization. In the sampling stage, the analog signal is measured (or sampled) at specific intervals, and the values obtained are stored as digital samples. In the quantization stage, the amplitude of each sample is rounded off to the nearest digital value, based on the number of bits used for representation. The accuracy of ADC 708 depends on several factors, such as the sampling rate, resolution, DC offset, and signal-to-noise ratio (SNR). The sampling rate determines how often the analog signal is sampled, while the resolution determines the number of bits used to represent each sample. The DC offset, as described above, affects the true value of the ADC 708′s output. The SNR is a measure of the ratio between the signal power and the noise power, and it determines how accurately the ADC 708 can distinguish between the signal and the noise.

After ADC 708 converts the voltage signals from analog signals to digital signals. The digital signals are sent to control circuitry 350 as ADC data. As described above, control circuitry 350 may include one or more processors (e.g., processor 712) and memory devices (e.g., memory 714) for processing the ADC data to determine, e.g., the timing of the return light pulses for distance calculation and point cloud construction.

The distance calculation is illustrated above in FIGS. 5A-5C. Referring back to FIGS. 5A-5C, a LiDAR system (e.g., system 300 or 500) determines the distance to objects 506 and 514 by measuring the time-of-flight of a light pulse from the time when a light pulse leaves the LiDAR system (e.g., outgoing light pulses 502, 522, and 530) to the time when the light pulse scattered from the object (e.g., return light pulses 508, 542, and 548) arrives back at the LiDAR system. Distance to objects 506 and 514 can be determined by multiplying the time-of-flight and the speed of light. As the speed of light is approximately 30 kilometers per second, the distance that light can travel in one nanosecond is approximately 0.3 meters. Since time-of-flight is a measurement of a light pulse’s roundtrip travel time, a miscalculation of one nanosecond of time-of-flight can result in an error of approximately 0.15 meters in distance measurement. Therefore, the ability to accurately calculate time-of-flight plays an important role for a LiDAR system to determine the distance to an object.

With reference back to FIG. 7, the output of amplifier 706 can be a continuous-time and continuous-amplitude analog voltage signal which resembles the waveform of the return light pulses 508, 542, and 548 in FIG. 5C. In one embodiment, ADC 708 samples the analog voltage signal from amplifier 706 at a fixed sampling rate, e.g., at a sampling rate of 1 nanosecond, which is equivalent to a sampling frequency of 1 GHz, and assigns a discrete value to each sample. Each discrete value represents the amplitude of the analog voltage signal of the return light pulse at each sampling time. This process results in a discrete-time digital pulse signal that approximates the original continuous-time analog signal of the return light pulse. As described above, the ADC output provided by ADC 708 may include signals representing the return light pulses and DC offset caused by, e.g., noise. Therefore, the ADC output needs to be at least partially corrected to remove the DC offset.

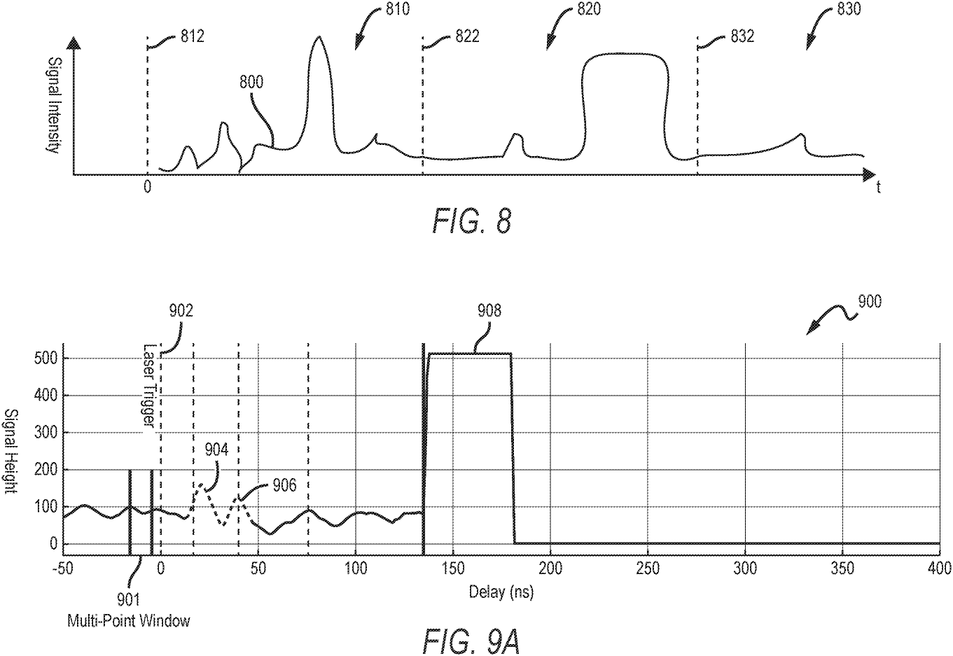

FIG. 8 illustrates example ADC data and laser triggers in multiple continuous firing cycles. In a LiDAR system, light is emitted from a rapidly firing laser. The laser can fire hundreds of thousands of pulses per second. These light pulses are reflected by objects in the FOV, and at least a portion of the reflected light return to the LiDAR system to form return light pulses. The LiDAR system uses the time it takes for each pulse to return to calculate distance, i.e., time of flight (ToF). Each of these pulsed laser measurements, or returns, can be processed into a 3D visualization known as a “point cloud”. A firing cycle is a period of time taken up by two immediately adjacent pulse firings. In some embodiments, a firing cycle begins at a time position of a laser trigger and ends at the time position of the next laser trigger (but does not include the time position of the next laser trigger). In FIG. 8, the horizontal axis represents the time axis representing the lapse of time or a delay time from the start time of a firing cycle or time position “0”. Signal line 800 represents an example ADC signal line of multiple continuous firing cycles. The time position of laser trigger 812 is the start time when the LiDAR system fires a transmission light pulse, which is transmitted to the FOV external to the LiDAR system. In some embodiments, this start time is equivalent to the time when the laser triggers to fire a pulse or when the outgoing light pulse leaves the LiDAR system. The vertical axis represents the signal intensity (e.g., voltage amplitude) of the waveform. As shown in FIG. 8, a first firing cycle 810 begins at time position of laser trigger 812 and ends at the time position of laser trigger 822 (excluding the time position of laser trigger 822). The first firing cycle 810 is followed by a second firing cycle 820. The second firing cycle 820 begins at the time position of laser trigger 822 and ends at the time position of laser trigger 832 (excluding time position of laser trigger 822). Similarly, the second firing cycle 820 is followed by a third firing cycle 830, and so forth. Third firing cycle 830 begins at the time position of laser trigger 832. For illustration purposes, second firing cycle 820 may be denoted as the current firing cycle. First firing cycle 810 may be denoted as the previous firing cycle. And third firing cycle 830 may be denoted as the next firing cycle. In some embodiments, one or more transmission pulses are fired in each firing cycle. For instance, if the LiDAR system has one or more transmitter channels or light sources, each firing cycle may have one or more transmission pulses. For illustration purposes, the description below uses one pulse firing for each firing cycle.

As described above ADC data may have DC offset. Such DC offset is illustrated in FIG. 9A, where the ADC data of a current firing cycle 900 has certain signal intensity even if there is no return light pulse received. In FIG. 9A, the DC offset is approximately 90 ADC count. An ADC count represents the signal intensity of the ADC output. The higher the ADC count, the larger the signal intensity. As described above, the DC offset can be determined and at least partially correct by using the methods disclosed in greater details below. In some examples, control Circuitry 350 (as shown in FIG. 7) comprises one or more processors and memory device including processor 712 and memory 714, which can be used to perform operations to determine the DC offset for each firing cycle of a plurality of firing cycles.

In some embodiments, determining the DC offset includes first determining a multiple-point time window using the ADC data. FIGS. 9A-9D illustrate example ADC data with different selections of multiple-point time window positions. Each of the FIGS. 9A-9D illustrates at least a portion of a firing cycle. In FIG. 9A, the horizontal axis is the time axis representing the delay of time measured from the time position of laser trigger 902 (i.e., the zero time position). The time position of laser trigger 902 is the start time of the current firing cycle 900 shown in FIG. 9A. The delay of time can be expressed, for example, in nanoseconds. The vertical axis in FIG. 9A represents the signal intensity (e.g., amplitude) of the ADC data. The ADC data is a digital output from the ADC approximating the analog waveform of the return signals detected by the LiDAR system.

Following time position of laser trigger 902, the ADC data shown in FIG. 9A includes signal pulses 904, 906, and 908. Signal pulse 904 may represent the a reference light signal. The reference light signal can be formed from a transmission light pulse and is used as a reference point to measure the distance of an object in the FOV. Signal pulse 906 may represent a scattered light pulse. When a transmission light pulse is scattered by certain LiDAR components such as a window, a mirror, etc., it forms scattered light pulse that can be detected by the optical receiver and detector of the LiDAR system. The scattered light pulse is then converted to digital signals by the ADC to form a part of the ADC data. Signal pulse 908 may represent a reflected light pulse. The reflected light pulse is formed by reflecting the transmission light pulse by an object in the FOV. This reflected light pulse is a desired light pulse for detecting the object and measuring the distance of the object. FIG. 9C shows the same ADC data as that shown in FIG. 9A. In both FIGS. 9A and 9C, signal pulse 908 has a flat top portion, indicating that the signal intensity of the ADC input signal representing the reflected light pulse exceeds the dynamic range of the ADC. In other words, the input signal The dynamic range of an ADC is the difference between the largest and smallest values it can convert. The dynamic range of an ADC is determined by the number of bits used to represent the digital output of the ADC. For example, an 8-bit ADC has a dynamic range of 48 dB, meaning it can represent a signal with a maximum amplitude 48 dB greater than its minimum detectable amplitude. A 16-bit ADC has a dynamic range of 96 dB, which is much greater than an 8-bit ADC.

FIGS. 9B and 9D illustrate ADC data of another firing cycle. Following the time position of laser trigger 922, the ADC data in FIGS. 9B and 9D includes signal pulses 924, 926, and 928. Signal pulse 924 may represent a reference light signal. Signal pulse 926 may represent a scattered light pulse. Signal pulses 924 and 926 can be formed in a similar manner as signal pulses 904 and 906, respectively, and are thus not repeatedly described. In ADC data of FIGS. 9B and 9D, signal pulse 928 may represent a reflected light pulse. The reflected light pulse is formed by reflecting a transmission light pulse by an object in the FOV. Unlike signal pulse 908 shown in FIG. 9A, signal pulse 928 does not have a flat top, indicating that the ADC is not saturated by the input signal representing the reflected light pulse in this scenario. That is, the ADC input signal representing the reflected light pulse in this case is within the dynamic range of the ADC.

In FIGS. 9A and 9C, an average DC offset is approximately 90 ADC count. In FIGS. 9B and 9D, an average DC offset is approximately 40 ADC count. Therefore, as can be seen from FIGS. 9A-9D, the DC offset varies for different firing cycles. To at least partially correct the DC offset from the ADC data, a multiple-point time window is determined based on the ADC data. A multiple-point time window can be positioned based on time positions of digital signals representing one or more of the detected return signals. Because the multiple-point time window is used to measure the DC offset of the ADC data, it is thus better to select a time window during which the ADC data do not include any signals representing signal pulses (e.g., reference signal pulses, scattered light pulse, or reflected light pulses). In other words, the multiple-point time window should be selected such that within the time window, the ADC data include entirely or substantially just noise that caused the DC offset.

FIGS. 9A-9D provide several examples where the multiple-point time window may be positioned. In some embodiments, a multiple-point time window can be positioned within a previous firing cycle before a time position associated with a laser triggering of a current firing cycle. For example, as shown in FIG. 9A, the time position of laser trigger 902 (represented by a dashed line) separates a current firing cycle 900 from its previous firing cycle. A multiple-point time window 901 is positioned slightly before the time position of laser trigger 902 in the previous firing cycle. Within the multiple-point time window 901, there is no signal pulses. That is, the positioning of the multiple-point time window 901 avoids any positions having signal pulses.

Similarly, in FIG. 9B, a multiple-point time window 921 is positioned slightly before time position of laser trigger 922. The time position of laser trigger 922 separates a current firing cycle 920 from its previous firing cycle. Thus, the multiple-point time window 921 is positioned within the previous firing cycle while avoiding any time positions associated with signal pulses. Typically, time positions within a firing cycle that have no signal pules (but only noises) can be found in the vicinity of the laser trigger time position. FIGS. 9A and 9B show ADC data of two different firing cycles that have different DC offsets (e.g., average DC offset for ADC data in FIG. 9A is about 90 counts while the average DC offset for ADC data in FIG. 9B is about 40 counts). The difference in offsets may be due to different types of objects detected by LiDAR. In this case, using a constant DC offset for all firing cycles cannot sufficiently correct ADC data in both firing cycles to a base of, e.g., zero. For instance, it is insufficient to correct the ADC data for firing cycle 900 with an DC offset of 90 counts by merely subtracting 40 counts obtained from the firing cycle 920. On the other hand, if both firing cycles shown in FIGS. 9A and 9B are applied a correction of 90 counts, the DC offset in firing cycle 920 may be over-corrected.

In some embodiments, a multiple-point time window can be positioned between a previous firing cycle and a current firing cycle. For example, as shown in FIG. 9C and similar to FIG. 9A, the time position of laser trigger 902 separates a current firing cycle 900 from a previous firing cycle. A multiple-point time window 931 can be positioned between the current firing cycle 900 and its previous firing cycle, e.g., straddling across the time position of laser trigger 902.

In some embodiments, a multiple-point time window can be positioned before a time position associated with digital signals representing a first pulse of the detected return signals in the current firing cycle. For example, as shown in FIG. 9D, a multiple-point time window 941 is positioned before the signal pulse 924. Signal pulse 924 represents the first pulse of the detected return signals in the current firing cycle. In some embodiments, the multiple-point time window 941 is positioned entirely within the current firing cycle 920 (e.g., after the time position of laser trigger 922). In other embodiments, the multiple-point time window 941 may straddle across the time position of laser trigger 922. It is understood that the multiple-point time window can be positioned in any time positions while avoiding including time positions associated with signals representing light pulses.

In some embodiments, with a properly positioned multiple-point time window, the DC offset can be determined. For example, after a multiple-point time window is positioned, control circuitry (e.g., circuitry 350) can obtain time positions of the determined multiple-point time window for determining the offset of the ADC data. The control circuitry may further obtain signal intensities of the ADC data corresponding to the time positions of the multiple-point time window, and compute the offset based on of the signal intensities of the ADC data corresponding to the time positions of the multiple-point time window.

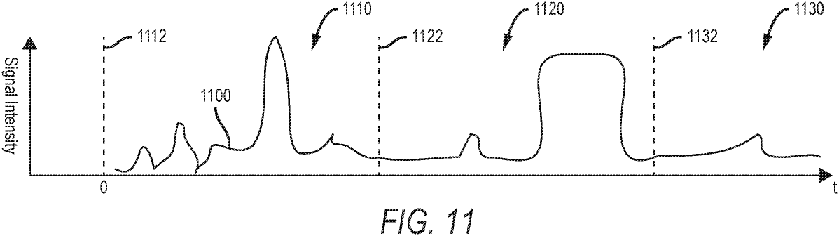

FIG. 10 is a zoomed-in view illustrating an example multiple-point time window 1021 for calculating DC offset. Time window 1021, in one example, can be a 16-point window. In other examples, time window 1021 can include more time points or time positions (e.g., 20, 24, 32). Including a smaller number of data points (e.g., 2 or 4 points) in a time window may cause the calculated value to be less representative of the overall DC offset in the firing cycle. Including too many data points, on the other hand, may cause difficulty to find a proper position to place the time window while still avoiding including signals representing light pulses. Thus, the number of points in the time window should be selected properly.

In FIG. 10, the horizontal axis is the time axis representing the lapse of time t. The vertical axis represents the signal intensity of the ADC output (e.g., ADC count). In some embodiments, the time position of laser trigger 1022, represented by the vertical dashed line, separates a current firing cycle 1020 and a previous firing cycle 1010. As shown in FIG. 10, firing cycle 1010 represents a previous firing cycle (also referred to as a first firing cycle). Firing cycle 1020 represents a current firing cycle (also referred to as a second firing cycle). In this example shown in FIG. 10, a 16-point time window 1021 is positioned within previous firing cycle 1010 before a time position associated with laser trigger of current firing cycle 1020. The 16-point time window 1021 shown in FIG. 10 is a zoomed-in view and not to scale. The control circuitry (e.g., circuitry 350) obtains time positions of the 16-point time window 1021. The time positions of time window 1021 include time positions from t1 to t16. In this example, the 16-point time window 1021 comprises 16 consecutive data points in a time period from time positions t1 to t16. In other examples, the data points may not be consecutive.

The control circuitry further obtains signal intensities of the ADC data corresponding to the time positions t1 to t16 of the 16-point time window 1021. The control circuitry can compute the offset based on the signal intensities of these 16 data points. In some embodiments, computing the offset based on of the signal intensities of the ADC data corresponding to the time positions of a multiple-point time window includes computing at least one of: a mean value of the signal intensities, a weighted mean value of the signal intensities, a median value of the signal intensities; and a mode of the signal intensities. A mean value is calculated as an average value of the signal intensities by computing a sum of the signal intensities of the data points and dividing the sum by the total number of data points. A weighted mean is an average value that takes into account the relative importance or weight of each value in a set of data. It is calculated by multiplying each value in the data set by its corresponding weight, adding up the products, and then dividing by the sum of the weights. A median value of a set of data is the middle value when the data is arranged in order from lowest to highest (or highest to lowest). It is a measure of central tendency that represents the value that separates the lower 50% of the data from the upper 50%. If the data set has an even number of values, the median is the average of the two middle values. To calculate the median, the values can be arranged in order from lowest to highest (or highest to lowest). Then, if the number of values in the data set is odd, the median is the middle value. If the number of values in the data set is even, the median is the average of the two middle values. A mode of a set of data is the value that appears most frequently in the data set. It is a measure of central tendency that represents the most common value in the data set. A data set can have one mode (unimodal), two modes (bimodal), or more than two modes (multimodal). To find the mode, it is determined which value appears most frequently in the data set.

Using the mean value as an example, as shown in FIG. 10, the offset based on of the signal intensities of the ADC data corresponding to the time positions of the 16-point time window 1021 can be computed by calculating a sum of the values of the signal intensities corresponding to time positions from t1 to t16, and then dividing the sum by 16. The calculated offset is illustrated as offset 1023 in FIG. 10. It is understood that the offset can be calculated in any manner (e.g., weighted mean, median, mode, linear regression, etc.) for each firing cycle. For different firing cycles, control circuitry may use the same or different method to calculate the DC offset for the particular firing cycle, thereby realizing real-time monitoring of the DC offset from cycle-to-cycle.

In some embodiments, using the computed offset for each firing cycle, the control circuitry can at least partially correct the ADC data based on the offset and provide the corrected ADC data for constructing a point cloud representing an external environment of the LiDAR system. For example, the ADC data for each firing cycle can be corrected by subtracting the offset from the ADC data. Depending on where the multiple-point time window is positioned, in some examples, the offset computed using a time window positioned in a previous firing cycle can be used to correct the ADC data in a current firing cycle. FIG. 11 illustrates exemplary offset-corrected ADC data in multiple continuous firing cycles. Similar to FIG. 8, the horizontal axis is the time axis representing the lapse of time t. The vertical axis represents the signal intensity (e.g., voltage amplitude) of the ADC output signal. Signal line 1100 represents an example ADC signal line of multiple continuous firing cycles. As shown in FIG. 11, previous firing cycle (first firing cycle) 1110 begins with time position of laser trigger 1112 and ends at the time position of laser trigger 1122 (excluding the time point of laser trigger 1122). Thus, the previous firing cycle (first firing cycle) 1110 is followed by current firing cycle (second firing cycle) 1120, which is followed by a next firing cycle (third firing cycle) 1130. The current firing cycle (second firing cycle) 1120 begins with time position of laser trigger 1122 and ends at the time position of laser trigger 1132 (excluding the time point of laser trigger 1132). If a multiple-point time window is positioned in firing cycle 1110 in the vicinity of time position of laser trigger 1122, the offset computed based on this time window can be used for firing cycle 1120. That is, an offset computed based on a time window positioned in a previous firing cycle can be used for correcting ADC data of the next firing cycle.

In other embodiments, the time window may be positioned within the current firing cycle 1120 in the vicinity of time position of laser trigger 1122 (e.g., right after laser trigger 1122). In this case, the offset computed based on this time window can be used to correct ADC data of the current firing cycle 1120 (or next firing cycle 1130). While the offset in different firing cycles may vary, under certain circumstances, ADC data of the neighboring firing cycles may have similar offsets. Thus, using offset computed for a neighboring firing cycle to correct ADC data of a current firing cycle may be acceptable. While FIG. 11 shows that firing cycles 1110 and 1120 are immediately neighboring cycles, and the offset computed based on a time window in firing cycle 1110 is used for correcting offset of ADC data in firing cycle 1120, it is understood that the cycles do not have to be immediately neighboring. For example, offset computed based on a time window positioned in firing cycle 1110 may also be used for correcting offset of ADC data in cycle 1130. Compared to the ADC data shown in FIG. 8, the DC offset of the ADC data shown in FIG. 11 are at least partially corrected.

In some embodiments, computing the offset is based on a preset initial value of the offset. In some examples, negative ADC data cannot be recorded or used for constructing a 3D point cloud. As a result, an offset may be preset with a small positive value. As a result, if correcting the original ADC data with the offset computed based on the multiple-point time window method would result in negative values. The small positive initial value of the offset can change the original negative values to be positive, so they can be recorded. In some embodiments, a preset initial value of offset can be 40. Once the offset is computed, the ADC data can be at least partially corrected based on the offset, taking into account the initial value.

FIG. 12 is a flowchart illustrating using an exemplary method 1200 for real-time monitoring of DC offsets of analog-to-digital (ADC) data of a LiDAR system. In some embodiments, method 1200 may be performed by LiDAR systems 300 or 700 shown in FIGS. 3 and 7. Method 1200 may also be performed by other devices (e.g., a remote server, an onboard computer of a vehicle, etc.). Method 1200 includes step 1204, in which a light source is configured to provide transmission light signals in a plurality of firing cycles. Referring back to FIG. 3, LiDAR system 300 transmits outgoing light pulses generated by light source 310 via transmitter 320 and steering mechanism 340 to the field of view. The starting point of the time-of-flight calculation is the time when the outgoing light pulse is generated, or when the outgoing light pulse leaves the LiDAR system. Method 1200 further includes step 1206, in which the LiDAR system detects return signals formed based on the transmission light signals. The return signals are being detected by optical receiver and light detector 330.

In some embodiments, method 1200 further includes step 1208-1216, which are also performed by optical receiver and light detector 330 and/or control circuitry 350. At step 1206, optical receiver and light detector 330 and/or control circuitry 350 obtains ADC data based on the detected return signals (e.g., by using a light detector, an amplifier, and an ADC, as described above). At step 1210, control circuitry 350 determines a multiple-point time window using the ADC data. In some embodiments, a multiple-point time window may be positioned based on time positions of digital signals representing one or more of the detected return signals. In some embodiments, a multiple-point time window may be positioned within a previous firing cycle before a time position associated with a triggering of a current firing cycle, between a previous firing cycle and a current firing cycle or within the current firing cycle, or before a time position associated with digital signals representing a first pulse of the detected return signals in the current firing cycle. At step 1212, based on the determination of the multiple-point time window, control circuitry 350 determines an offset of the ADC data. In some embodiments, determining the offset of the ADC data comprises obtaining time positions of the determined multiple-point time window, obtaining signal intensities of the ADC data corresponding to the time positions of the multiple-point time window, and computing the offset based on of the signal intensities of the ADC data corresponding to the time positions of the multiple-point time window. In some embodiments, computing the offset based on of the signal intensities of the ADC data corresponding to the time positions of the multiple-point time window comprises computing at least one of: a mean value of the signal intensities, a weighted mean value of the signal intensities, a median value of the signal intensities, and a mode of the signal intensities.

At step 1214, control circuitry 350 at least partially corrects the ADC data based on the offset. In some embodiments, control circuitry 350 further subtracts the offset from the ADC data representing detected return signals in a first firing cycle from the ADC data representing detected return signals in a second firing cycle. At step 1216, control circuitry 350 provides the corrected ADC data for constructing a point cloud representing an external environment of the LiDAR system.

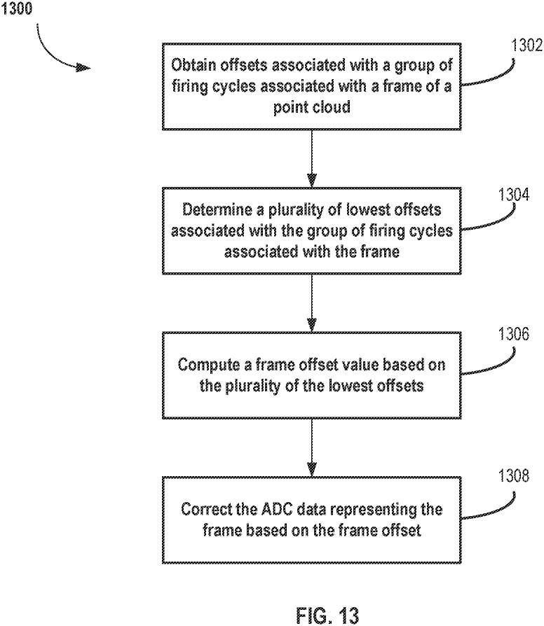

FIG. 13 is a flowchart illustrating using an exemplary method for real-time monitoring of a frame offset of analog-to-digital (ADC) data of a LiDAR system. In some embodiments, instead of calculating offset for every firing cycle, a frame offset is determined for a frame comprising a plurality of firing cycles. In some embodiments, method 1300 may be performed by LiDAR systems 300 or 700 in FIGS. 3 and 7, including a control circuitry 350. At step 1302, control circuitry 350 obtains offsets associated with a group of firing cycles of the plurality of firing cycles. Each of the offsets associated with the group of firing cycles can be obtained using the methods described above. The group of firing cycles is associated with a frame of the point cloud. A frame of the point cloud data may be generated by the LiDAR system when it completes scanning of an entire FOV. For instance, when a mirror of the LiDAR system completes scanning from top to bottom of the vertical FOV, the LiDAR system may generate one frame of point cloud data. For generating the one frame, many firing cycles (e.g., 20,000) may be needed.

At step 1304, control circuitry 350 determines a plurality of lowest offsets associated with the group of firing cycles associated with the frame. For example, the control circuitry 350 can sort or rank the offsets for all firing cycles in a frame from low to high, and select those lowest offsets that are below a threshold (e.g., 40 ADC counts). At step 1306, control circuitry 350 computes a frame offset value based on the plurality of the lowest offsets. The frame offset represents an offset of the ADC data representing the frame. For instance, control circuitry 350 may compute a mean, a weighted mean, a median, a mode, etc. of the lowest offsets. This value can be used as the frame offset. At step 1306, control circuitry 350 at least partially corrects the ADC data representing the frame based on the frame offset.

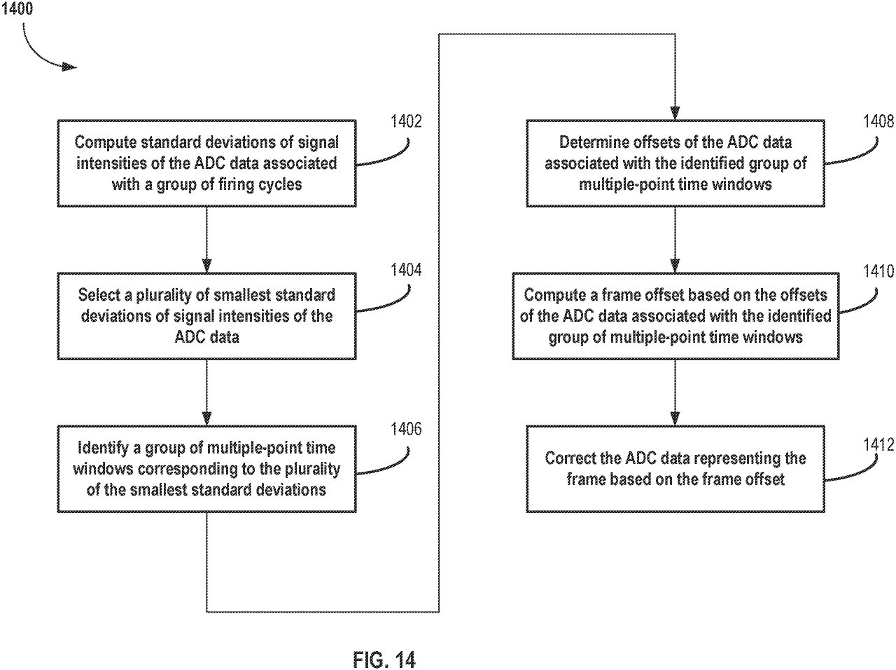

Similarly, FIG. 14 is a flowchart illustrating using an exemplary method 1400 for real-time monitoring of a frame offset of analog-to-digital (ADC) data for a group of firing cycles of the plurality of firing cycles of a LiDAR system. In some embodiments, a group of firing cycles is associated with a frame of the point cloud. In some embodiments, at step 1402, control circuitry 350 computes standard deviations of signal intensities of the ADC data associated with a group of firing cycles associated with a frame of the point cloud. For instance, based on the ADC data for 20,000 firing cycles, control circuitry 350 can calculate the standard deviations representing the spread of the ADC data.

At step 1404, control circuitry 350 selects, from the computed standard deviations, a plurality of smallest standard deviations of signal intensities of the ADC data associated with the group of firing cycles. A small standard deviation indicates that the ADC data tend to be close to the mean, while a large standard deviation indicates that the ADC data are more spread out. Thus, the smallest standard deviations are more representative of the mean value of the ADC data for all firing cycles in a frame.

At step 1406, control circuitry 350 identifies, from multiple-point time windows associated with the group of firing cycles, a group of multiple-point time windows corresponding to the plurality of the smallest standard deviations of the signal intensities of the ADC data associated with the group of firing cycles. For instance, for the smallest standard deviations, control circuitry 350 may identify 20-50 multiple-point time windows for the corresponding 20-50 firing cycles. The identification of the multiple-point time windows can use the same or similar method as described above (e.g., positioning the time windows in the vicinity of the laser trigger time positions).

At step 1408, control circuitry 350 determines offsets of the ADC data associated with the identified group of multiple-point time windows. The offset determination can be performed using the methods described above (e.g., calculating the mean, median, weighted mean, mode, etc.) of the data points in the time windows. At step 1410, control circuitry 350 computes a frame offset based on the offsets of the ADC data associated with the identified group of multiple-point time windows. The frame offset represents an offset of the ADC data representing the frame. For instance, control circuitry 350 may compute a mean, a weighted mean, a median, a mode, etc. of the multiple offsets to obtain the frame offset. At step 1412, control circuitry 350 at least partially corrects the ADC data representing the frame based on the frame offset.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A light detection and ranging (LiDAR) system comprising:
a light source configured to provide transmission light signals in a plurality of firing cycles;
a detector configured to detect return signals formed based on the transmission light signals;
an analog-to-digital converter (ADC) configured to obtain ADC data representing the detected return signals; and
one or more processors and memory device, and processor-executable instructions stored in the memory device, the processor-executable instructions, when executed by the one or more processors, cause the one or more processors to perform, for at least one firing cycle of the plurality of firing cycles:
determining a multiple-point time window using the ADC data;
based on the multiple-point time window, determining an offset of the ADC data;
at least partially correcting the ADC data based on the offset; and
providing the corrected ADC data for constructing a point cloud representing an external environment of the LiDAR system.

2. The system of claim 1, wherein determining the multiple-point time window using the ADC data comprises positioning the multiple-point time window based on time positions of digital signals representing one or more of the detected return signals.

3. The system of claim 2, wherein the multiple-point time window is positioned within a previous firing cycle before a time position associated with a triggering of a current firing cycle.

4. The system of claim 2, wherein the multiple-point time window is positioned between a previous firing cycle and a current firing cycle or within the current firing cycle.

5. The system of claim 2, wherein the multiple-point time window is positioned before a time position associated with digital signals representing a first pulse of the detected return signals in the current firing cycle.

6. The system of claim 1, wherein based on the multiple-point time window, determining the offset of the ADC data comprises:
obtaining time positions of the determined multiple-point time window;
obtaining signal intensities of the ADC data corresponding to the time positions of the multiple-point time window; and
computing the offset based on of the signal intensities of the ADC data corresponding to the time positions of the multiple-point time window.

7. The system of claim 6, wherein computing the offset based on of the signal intensities of the ADC data corresponding to the time positions of the multiple-point time window comprises computing at least one of:
a mean value of the signal intensities;
a weighted mean value of the signal intensities;
a median value of the signal intensities; and
a mode of the signal intensities.

8. The system of claim 6, wherein computing the offset is further based on a preset initial value of the offset.

9. The system of claim 1, wherein at least partially correcting the ADC data based on the offset comprises:
subtracting the offset from the ADC data representing detected return signals in a first firing cycle from the ADC data representing detected return signals in a second firing cycle, the first firing cycle preceding the second firing cycle.

10. The system of claim 1, wherein the processor-executable instructions comprise further instructions, when executed by the one or more processors, cause the one or more processors to perform:
obtaining offsets associated with a group of firing cycles of the plurality of firing cycles, the group of firing cycles being associated with a frame of the point cloud;
determining a plurality of lowest offsets associated with the group of firing cycles associated with the frame;
computing a frame offset value based on the plurality of the lowest offsets, the frame offset representing an offset of the ADC data representing the frame; and
at least partially correcting the ADC data representing the frame based on the frame offset.

11. The system of claim 1, wherein the processor-executable instructions comprise further instructions, when executed by the one or more processors, cause the one or more processors to perform, for a group of firing cycles of the plurality of firing cycles, the group of firing cycles being associated with a frame of the point cloud:
computing standard deviations of signal intensities of the ADC data associated with the group of firing cycles;
selecting, from the computed standard deviations, a plurality of smallest standard deviations of signal intensities of the ADC data associated with the group of firing cycles;
identifying, from multiple-point time windows associated with the group of firing cycles, a group of multiple-point time windows corresponding to the plurality of the smallest standard deviations of the signal intensities of the ADC data associated with the group of firing cycles;
determining offsets of the ADC data associated with the identified group of multiple-point time windows;
computing a frame offset based on the offsets of the ADC data associated with the identified group of multiple-point time windows;, the frame offset representing an offset of the ADC data representing the frame; and
at least partially correcting the ADC data representing the frame based on the frame offset.

12. The system of claim 1, wherein the multiple-point time window comprises a 16-point time window.

13. A method for real-time offset monitoring for light detection and ranging (LiDAR), the method comprising:
providing, by a light source, transmission light signals in a plurality of firing cycles;
detecting, by a detector, return signals formed based on the transmission light signals;
obtaining, by an analog-to-digital converter (ADC), ADC data representing the detected return signals; and
executing, by one or more processors and memory device, processor-executable instructions to cause the one or more processors to perform, for at least one firing cycle of the plurality of firing cycles:
determining a multiple-point time window using the ADC data;
based on the multiple-point time window, determining an offset of the ADC data;
at least partially correcting the ADC data based on the offset; and
providing the corrected ADC data for constructing a point cloud representing an external environment of the LiDAR system.

14. The method of claim 13, wherein determining the multiple-point time window using the ADC data comprises positioning the multiple-point time window based on time positions of digital signals representing one or more of the detected return signals.

15. The method of claim 14, wherein the multiple-point time window is positioned within a previous firing cycle before a time position associated with a triggering of a current firing cycle.

16. The method of claim 14, wherein the multiple-point time window is positioned between a previous firing cycle and a current firing cycle.

17. The method of claim 14, wherein the multiple-point time window is positioned before a time position associated with digital signals representing a first pulse of the detected return signals in the current firing cycle.

18. The method of claim 13, wherein based on the multiple-point time window, determining the offset of the ADC data comprises:
obtaining time positions of the determined multiple-point time window;
obtaining signal intensities of the ADC data corresponding to the time positions of the multiple-point time window; and
computing the offset based on of the signal intensities of the ADC data corresponding to the time positions of the multiple-point time window.

19. The method of claim 18, wherein computing the offset based on of the signal intensities of the ADC data corresponding to the time positions of the multiple-point time window comprises computing at least one of:
a mean value of the signal intensities;
a weighted mean value of the signal intensities;
a median value of the signal intensities; and
a mode of the signal intensities.

20. The method of claim 18, wherein computing the offset is further based on a preset initial value of the offset.

21. The method of claim 13, wherein at least partially correcting the ADC data based on the offset comprises: subtracting the offset from the ADC data representing detected return signals in a first firing cycle from the ADC data representing detected return signals in a second firing cycle, the first firing cycle preceding the second firing cycle.

22. A non-transitory computer readable medium storing processor-executable instructions for performing correction of analog-to-digital (ADC) data obtained based on transmission light signals associated with a plurality of firing cycles, wherein the instructions, when executed by one or more processors of an electronic device, cause the electronic device to perform:
providing, by a light source, transmission light signals in a plurality of firing cycles;
detecting, by a detector, return signals formed based on the transmission light signals;
obtaining, by an analog-to-digital converter (ADC), ADC data representing the detected return signals; and
executing, by the one or more processors and memory device, processor-executable instructions to cause the one or more processors to perform, for at least one firing cycle of the plurality of firing cycles:
determining a multiple-point time window using the ADC data;
based on the multiple-point time window, determining an offset of the ADC data;
at least partially correcting the ADC data based on the offset; and
providing the corrected ADC data for constructing a point cloud representing an external environment of the LiDAR system.

23. A vehicle comprising a light detection and ranging (LiDAR) system, wherein the LiDAR system comprises:
a light source configured to provide transmission light signals in a plurality of firing cycles;
a detector configured to detect return signals formed based on the transmission light signals;
an analog-to-digital converter (ADC) configured to obtain ADC data representing the detected return signals; and
one or more processors and memory device, and processor-executable instructions stored in the memory device, the processor-executable instructions, when executed by the one or more processors, cause the one or more processors to perform, for at least one firing cycle of the plurality of firing cycles:
determining a multiple-point time window using the ADC data;
based on the multiple-point time window, determining an offset of the ADC data;
at least partially correcting the ADC data based on the offset; and
providing the corrected ADC data for constructing a point cloud representing an external environment of the LiDAR system.
